(19) United States
(12) Patent Application Publication
(10) Pub. No.: US 2026/0187216 A1
(43) Pub. Date: Jul. 2, 2026

(54) Methods And Devices For Authenticating Individuals Based On Dynamic Facial Expressions And Device Motion

(71) Applicant: BrainChip, Inc., Laguna Hills, CA (US)

(72) Inventor: Olivier Jean-Marie Dominique COENEN, Encinitas, CA (US)

(21) Appl. No.: 19/435,620

(22) Filed: Dec. 29, 2025

Related U.S. Application Data
(60) Provisional application No. 63/740,239, filed on Dec. 30, 2024.

(51) Int. Cl. G06F 21/32; G06F 21/35; G06V 10/147; G06V 10/24; G06V 10/74; G06V 10/75; G06V 10/82; G06V 40/16; G06V 40/40; G06V 40/70

(52) U.S. Cl. CPC G06F 21/32; G06F 21/35; G06V 10/24; G06V 10/751; G06V 10/761; G06V 10/82; G06V 40/172; G06V 40/174; G06V 40/40; G06V 10/147; G06V 40/70

(57) ABSTRACT

Various embodiments provide a secure biometric authentication method using dynamic facial expression gestures and motion. A mobile device captures spatiotemporal data of a user's facial features via a vision sensor and motion data associated with a mobile device's movement via an inertial measurement unit (IMU). A processing system in the mobile device constructs composite spatiotemporal trajectories of facial features by combining the event-based data and motion data, which are then matched to a stored template of biometric gestures associated with an authorized user. A neural network may be used to process these trajectories to determine the dynamic facial features and mobile device movements that correspond to an authorized user. If so, the mobile device may provide access to protected assets or secure operations of a device or to protected files. This dual-layer security approach enhances protection against unauthorized access by requiring precise replication of both facial dynamics and device motion.

### CROSS-REFERENCE TO RELATED APPLICATIONS

This application claims the benefit of priority to U.S. Provisional Patent Application No. 63/740,239 entitled “Methods And Devices For Authenticating Individuals Based On Dynamic Facial Expressions And Device Motion” filed Dec. 30, 2024, the entire contents of which are hereby incorporated by reference for all purposes.

### TECHNICAL FIELD

The present disclosure relates generally to the field of biometric authentication and mobile device security. More particularly, the present disclosure relates to systems and methods for verifying the identity of an individual by analyzing dynamic spatiotemporal data derived from facial expressions and synchronized device motion.

### BACKGROUND

Facial recognition technology has been widely adopted as a primary method for securing mobile devices and authorizing transactions. Conventional systems typically operate by capturing static images or short video frames of a user's face and comparing the geometric features against a stored static template. One of the most well-known implementations is Apple's Face ID, which uses a 3D sensor to project laser points onto the face, creating a detailed map of facial features. However, a technical problem persists with these static imaging approaches: they are inherently susceptible to “spoofing” or presentation attacks. Despite its effectiveness, there are concerns about the potential for spoofing, such as using a 3D model of a head to trick the system. Unauthorized actors can frequently deceive traditional sensors using high-resolution photographs, video playbacks on screens, or sophisticated 3D-printed masks that replicate the authorized user's static facial geometry. Furthermore, standard frame-based cameras often lack the temporal resolution necessary to detect subtle, rapid micro-expressions that distinguish a live user from a lifeless replica, and they struggle with high latency and motion blur when the device is moving.

To address these limitations, there is a need for advancements in facial recognition that include exploring dynamic elements. Solutions that include these advancements may make it significantly more challenging for unauthorized users to gain access to improve the overall reliability and robustness of facial recognition as a security measure.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The various aspects include methods and devices for authenticating an individual based on dynamic facial expressions and device motion. Some aspects may include capturing spatiotemporal data of a user's facial features via a vision sensor in a mobile device, in which the spatiotemporal data is either event-based data or image frame-based data, capturing motion data associated with movements of the mobile device via an inertial measurement unit (IMU), constructing composite spatiotemporal trajectories of facial features on the person's face by combining the spatiotemporal data and the motion data, matching the composite spatiotemporal trajectories of facial features to a stored template of biometric gestures associated with an authorized user, determining, based on the matching, whether the composite spatiotemporal trajectories of facial features corresponds to the stored template within a predefined threshold, and providing access to a protected asset or secure operation in response to determining that the composite spatiotemporal trajectory corresponds to the stored template within the predefined threshold.

Further aspects may include capturing spatiotemporal data regarding movements of a user's facial features via a vision sensor, in which the spatiotemporal data is either event-based data or image frame-based data, capturing motion data associated with a movement of a mobile device via an inertial measurement unit (IMU), processing the spatiotemporal data and the motion data in a neural network that is trained to infer whether movements of the user's facial features and mobile device motions match those of an authorized user, and providing access to a protected asset or secure operation in response to the neural network inferring that the dynamic facial features and mobile device motions match those of an authorized user.

Further aspects may include capturing spatiotemporal data regarding movements of the user's facial features via a vision sensor and motion data of the mobile device via an inertial measurement unit (IMU) in a training session, in which the spatiotemporal data is either event-based data or image frame-based data, and training or fine-tuning the neural network using the captured spatiotemporal data and motion data.

Further aspects may include capturing spatiotemporal data of a user's facial features via a vision sensor, in which the spatiotemporal data is either event-based data or image frame-based data, constructing spatiotemporal trajectories of facial features on the person's face, matching the spatiotemporal trajectories of facial features to a stored template of biometric gestures associated with an authorized user, determining, based on the matching, whether the spatiotemporal trajectories of facial features corresponds to the stored template within a predefined threshold, and providing access to a protected asset or secure operation in response to determining that the spatiotemporal trajectory corresponds to the stored template within the predefined threshold.

Further aspects may include a computing device having a vision-based sensor and at least one processor or processing system configured with processor-executable instructions to perform various operations corresponding to any of the methods summarized above. Further aspects may include a computing device having various means for performing functions corresponding to the method operations summarized above. Further aspects may include a non-transitory processor-readable storage medium having stored thereon processor-executable instructions configured to cause at least one processor or processing system to perform various operations corresponding to the method operations summarized above.

Embodiments disclosed include a method for secure biometric authentication. The method may include capturing, via a sensor in a mobile device, spatiotemporal data associated with facial features of a user, wherein the spatiotemporal data is either event-based data or image frame-based data. The method may further include capturing, via an inertial measurement unit (IMU), motion data associated with a movement of the mobile device. The method may further include combining the spatiotemporal event-based data and the motion data into a single data structure to generate a composite spatiotemporal trajectory, the composite spatiotemporal trajectory representing interplay between facial features of the user and the movements associated with the mobile device. The method may further include comparing the composite spatiotemporal trajectory with a stored template, the stored template designated as a biometric gesture associated with an authorized user. The method may further include determining, based on the comparing, whether the composite spatiotemporal trajectory and the stored template match with each other beyond a predefined threshold value of a similarity measure. The method may further include providing the user access to a protected asset or authorization to perform a secure operation in response to determining that the composite spatiotemporal trajectory and the stored template match with each other beyond the predefined threshold value of a similarity measure.

In some embodiments, the method may include separately or independently processing the spatiotemporal data associated with facial features of the user and the motion data associated with a movement of the mobile device, without combining the two. In some embodiments, the method may include determining a first score associated with the spatiotemporal data associated with facial features of the user and a second score associated with the motion data associated with a movement of the mobile device. In some embodiments, the first score can be compared with a stored first template designated as a spatiotemporal data associated with an authorized user and the second score can be compared with a second template designated as motion data associated with an authorized user. The first score can be used to determine if the spatiotemporal data associated with facial features of the user match the first template designated as a spatiotemporal data associated with an authorized user beyond a predefined threshold value of a similarity measure, and the second score can be used to determine if the motion data associated with the movement of the mobile device match the second template designated as a motion data associated with an authorized user beyond a predefined threshold value of a similarity measure. In some embodiments, the first score and the second score can then be combined to generate a combined score that can then be used to determine if the spatiotemporal data associated with facial features of the user and the motion data associated with the movement of the mobile device together match the first template designated as a spatiotemporal data associated with an authorized user and the second template designated as a motion data associated with an authorized user beyond a predefined threshold value of a similarity measure.

Alternatively, in some embodiments, the method may include determining a first score associated with the spatiotemporal data associated with facial features of the user and a second score associated with the motion data associated with a movement of the mobile device. The first score can represent a degree of similarity between the spatiotemporal data associated with facial features of the user and the first template designated as a spatiotemporal data associated with an authorized user. The second score can represent a degree of similarity between the motion data associated with the movement of the mobile device and the second template designated as motion data associated with an authorized user. In some embodiments, the first score and the second score can combined to generate a combined score that can then represent the combined degree of similarity of the spatiotemporal data associated with facial features of the user and the motion data associated with the movement of the mobile device with the first template designated as a spatiotemporal data associated with an authorized user and the second template designated as a motion data associated with an authorized user, which can then be used to determine if the combined similarity is beyond a predefined threshold value of a similarity measure.

In some embodiments, the spatiotemporal data may be spatiotemporal event-based data, the vision sensor may be an event-based vision sensor, and the capturing the spatiotemporal event-based data of the facial features of the user may include capturing spatiotemporal event-based data associated with facial feature movements of the user via the event-based vision sensor configured to detect changes in illumination or contrast at individual sensor pixels and output asynchronous events associated with the detected changes.

In some embodiments, the event-based vision sensor may output asynchronous events corresponding to changes in illumination or contrast with a temporal resolution of approximately one microsecond. In some embodiments, the event-based vision sensor may output asynchronous events corresponding to changes in illumination or contrast with a temporal resolution of approximately one nanosecond.

In some embodiments, the event-based vision sensor may output asynchronous events corresponding to changes in illumination or contrast with a temporal resolution ranging from approximately one nanosecond to hundreds of microseconds, including all intervals within this range. For example, the event-based vision sensor may operate with a temporal resolution of approximately one nanosecond, ten nanoseconds, few tens of nanoseconds, one hundred nanoseconds, one microsecond, ten microseconds, one hundred microseconds, few hundreds of microseconds, one millisecond, or any interval therebetween. The temporal resolution may be selected or dynamically adjusted based on the specific application requirements, processing capabilities, power constraints, or the speed of detected facial movements.

In some embodiments, the capturing the motion data associated with a movement of the mobile device may include capturing motion data associated with identifying a lateral motion of the mobile device, the lateral motion effective to detect information about a depth associated with the facial features of the user.

In some embodiments, capturing the motion data associated with a movement of the mobile device may include capturing motion data associated with identifying motion of the mobile device in any direction defined using three degrees of freedom. For example, the motion data may include lateral motion, vertical motion, forward and backward motion, or any combination thereof. The inertial measurement unit may capture translational movements along any axis as well as rotational movements about any axis, enabling the system to track complex motion trajectories of the mobile device during an authentication session. Such motion data may be used to detect information about depth and three-dimensional features of the user's face by imaging the user from varying angles or perspectives as the mobile device moves through space.

In some embodiments, the method may further include processing the spatiotemporal data by aligning and normalizing the data to remove noise and inconsistencies while maintaining temporal resolution prior to constructing the composite spatiotemporal trajectory.

In some embodiments, capturing the spatiotemporal data of the facial features of the user via a vision sensor may include capturing sparse spatiotemporal event-based data associated with the facial features of the user, without capturing an image of a face of the user, the sparse spatiotemporal event-based data being in a format that can be matched to a stored dynamical trajectory associated with facial features, the dynamical trajectory representing facial expression gestures, mobile device movements, or both combined.

In some embodiments, the method may further include detecting an inconsistency associated with temporal dynamics or spatial distortions in the spatiotemporal data, detecting a spoofing attempt based on analyzing the inconsistency, and initiating a protective action in response to detecting the spoofing attempt.

In some embodiments, the method may further include generating an alert in response to determining that the composite spatiotemporal trajectory and the stored template do not match with each other beyond the predefined threshold value of a similarity measure.

In some embodiments, the method may further include reconstructing a three-dimensional model of a face of the user based on the spatiotemporal data and the motion data, the three-dimensional model to be used to compare with a stored template of a three-dimensional model of an authorized user.

In some embodiments, comparing the composite spatiotemporal trajectory with the stored template may include comparing using a neural network trained on a set of spatiotemporal trajectories, each spatiotemporal trajectory from the set of spatiotemporal trajectories associated with a dynamic facial expression gesture and a device movement.

In some embodiments, the method may further include detecting a verified authentication event in response to determining that the composite spatiotemporal trajectory and the stored template match with each other beyond the predefined threshold value of a similarity measure, and updating the stored template designated as the biometric gesture associated with the authorized user in response to detecting the verified authentication event, the updating effective to adapt the stored template to changes in the facial features of the user over time.

In some embodiments, providing the user access to the protected asset or authorization to perform the secure operation may include providing access to at least one of unlocking the mobile device, authorizing a transaction, authorizing use of a vehicle, or granting access to a restricted resource or file.

In some embodiments, capturing the spatiotemporal data of the facial features of the user may include capturing spatiotemporal data of facial features that includes data associated with a micro-expression of the user.

In some embodiments, the method may further include focusing processing of data from the vision sensor on the face of the user to facilitate capturing the spatiotemporal data of the facial features of the user via the vision sensor.

In some embodiments, the method may further include dynamically adjusting the predefined threshold value of the similarity measure based on one or more environmental factors including a lighting condition and a mobile device orientation.

In some embodiments, the vision sensor and the IMU may be integrated into a single hardware module configured to perform real-time processing of spatiotemporal data.

In some embodiments, the method may further include performing an independent authentication check prior to providing access to the protected asset or secure operation, the additional independent authentication check being via a method including one or more of fingerprint verification, palmprint verification, voiceprint verification, facial recognition, password verification, or two-factor authentication.

A system for secure biometric authentication may include a vision sensor configured to capture spatiotemporal data associated with movements of a user's facial features, wherein the spatiotemporal data is either event-based data or image frame-based data. The system may further include an inertial measurement unit (IMU) configured to capture motion data associated with a movement of the computing device. The system may further include a memory. The system may further include a processor coupled to the vision sensor, the IMU, and the memory, the processor configured to process the spatiotemporal data and the motion data using a neural network that is trained to infer whether movements of the user's facial features and computing device motions match those of an authorized user, and provide access to a protected asset or secure operation in response to the neural network inferring that the dynamic facial features and computing device motions match those of an authorized user.

In some embodiments, the spatiotemporal data may be event-based data, and the vision sensor may be an event-based vision sensor configured to detect changes in illumination or contrast at individual sensor pixels and output asynchronous events corresponding to the detected changes.

In some embodiments, the neural network may use PLEIADES processing of the spatiotemporal event-based data and motion data to reduce latency and efficiently process high-frequency data to support dynamic facial expression gesture analyses and inference.

In some embodiments, the spatiotemporal data may be frame-based data, and the neural network may use Binned PLEIADES processing of the spatiotemporal event-based data and motion data that looks at multiple frames in the past to perform dynamic facial expression gesture analyses and inference.

In some embodiments, the vision sensor, the IMU, and a neural processing unit (NPU) implementing the neural network may be combined in a single integrated circuit assembly.

A method of training a neural network for secure biometric authentication may include capturing spatiotemporal data associated with movements of the user's facial features via a vision sensor and motion data of the mobile device via an inertial measurement unit (IMU) in a training session, wherein the spatiotemporal data is either event-based data or image frame-based data. The method may further include training or fine-tuning the neural network using the captured spatiotemporal event-based data and motion data.

In some embodiments, the method may further include prompting the user during the training session to make one or more facial expression gestures to be used for authenticating the user.

In some embodiments, the method may further include prompting the user during the training session to move the mobile device through one or more motions to be used for authenticating the user while making the one or more facial expression gestures.

A computing system may include a memory, a high-frame-rate vision sensor or an event-based vision sensor, an inertial measurement unit (IMU), a neural network processor, and a processor coupled to the memory, the vision sensor, the IMU, and the neural network processor, and configured to perform operations including capturing, via the vision sensor, spatiotemporal data associated with facial features of a user, capturing, via the IMU, motion data associated with a movement of the computing system, combining the spatiotemporal data and the motion data to generate a composite spatiotemporal trajectory, comparing the composite spatiotemporal trajectory with a stored template designated as a biometric gesture associated with an authorized user, determining whether the composite spatiotemporal trajectory and the stored template match with each other beyond a predefined threshold value of a similarity measure, and providing the user access to a protected asset or authorization to perform a secure operation in response to determining a match.

A computing system may include a memory, a high-frame-rate vision sensor or an event-based vision sensor, a neural network processor, and a processor coupled to the memory, the vision sensor, and the neural network processor, and configured to perform operations including capturing, via the vision sensor, spatiotemporal data associated with facial features of a user, processing the spatiotemporal data in a neural network trained to infer whether movements of the user's facial features match those of an authorized user, and providing access to a protected asset or secure operation in response to the neural network inferring that the dynamic facial features match those of an authorized user.

A computing device may include various means for performing functions including capturing spatiotemporal data associated with facial features of a user, capturing motion data associated with a movement of the computing device, combining the spatiotemporal data and the motion data to generate a composite spatiotemporal trajectory, comparing the composite spatiotemporal trajectory with a stored template designated as a biometric gesture associated with an authorized user, determining whether the composite spatiotemporal trajectory and the stored template match with each other beyond a predefined threshold value of a similarity measure, and providing the user access to a protected asset or authorization to perform a secure operation in response to determining a match.

A non-transitory processor-readable storage medium may have stored thereon processor-executable instructions configured to cause a processor of a computing device to perform various operations including capturing, via a sensor, spatiotemporal data associated with facial features of a user, capturing, via an inertial measurement unit, motion data associated with a movement of the computing device, combining the spatiotemporal data and the motion data to generate a composite spatiotemporal trajectory, comparing the composite spatiotemporal trajectory with a stored template designated as a biometric gesture associated with an authorized user, determining whether the composite spatiotemporal trajectory and the stored template match with each other beyond a predefined threshold value of a similarity measure, and providing the user access to a protected asset or authorization to perform a secure operation in response to determining a match.

The foregoing general description of the illustrative embodiments and the following detailed description thereof are merely exemplary aspects of the teachings of this disclosure and are not restrictive.

### BRIEF DESCRIPTION OF FIGURES

The accompanying drawings, which are incorporated herein and constitute part of this specification, illustrate exemplary aspects of the invention and, together with the general description given above and the detailed description given below, serve to explain the features of the invention.

FIGS. 1A and 1B are illustrations of a user performing a dynamic facial feature expression and device motion authentication process according to various embodiments.

FIG. 2 is a component block diagram illustrating example components in a system on chip processor suitable for use with various embodiments.

FIG. 3A is a process flow diagram illustrating an overview of a dynamic facial feature expression and device motion authentication process according to some embodiments.

FIG. 3B is a process flow diagram illustrating an overview of a dynamic facial feature expression authentication process according to some embodiments.

FIG. 4 is a block diagram illustrating example processing operations that may be performed in a neural network system useful for various embodiments.

FIG. 5 is a block diagram illustrating another example of processing operations that may be performed in a neural network system useful for various embodiments.

FIG. 6 is a functional block diagram illustrating components and processor-executable instruction modules of a user authentication system of various embodiments.

FIG. 7 is a process flow diagram illustrating an embodiment method for processing spatiotemporal data streams in a computing device to accomplish a user authentication process in accordance with some embodiments.

FIG. 8A is a process flow diagram illustrating an embodiment method for processing spatiotemporal data streams using a trained neural network to accomplish a user authentication process in accordance with some embodiments.

FIG. 8B is a process flow diagram illustrating an embodiment method for training a neural network to accomplish a user authentication process in accordance with some embodiments.

FIGS. 9A-9C are process flow diagrams that illustrate additional operations that may be performed as part of the methods illustrated in either of FIG. 7 or 8A in accordance with some embodiments.

FIG. 10 is a component block diagram illustrating an example edge computing device in the form of a mobile device that is suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References made to particular examples and implementations are for illustrative purposes and are not intended to limit the scope of the invention or the claims.

Embodiments disclosed address the technical problems of static imaging approaches that are inherently susceptible to “spoofing” or presentation attacks by providing a dynamic authentication framework that utilizes “motor signatures” rather than static imagery. The disclosed solution integrates data from an Event-Based Vision Sensor (EBVS) (or high-frame-rate camera) with motion data from the mobile device's Inertial Measurement Unit (IMU). Instead of matching a static face, the disclosed systems and methods capture high-frequency spatiotemporal trajectories generated by the user's specific facial muscle movements (expressions) synchronized with the physical movement associated with handling and/or movement of the device (e.g., the user's arm motion) in synchronized data streams. By processing these synchronized data streams, potentially using specialized neural networks capable of analyzing asynchronous events, the system constructs a complex, dynamic biometric signature. The disclosed approach aims to ensure that access is granted only when the specific dynamic interplay of facial gestures and device motion matches the authorized user's unique behavioral pattern, thereby rendering static spoofing attempts ineffective.

Various embodiments include mobile devices and methods providing a secure user authentication process that leverages dynamic facial recognition and mobile device motion detection. Unlike traditional facial recognition systems that rely on static images, various embodiments provide a secure biometric authentication method for a mobile device by using a combination of dynamic facial expression gestures and motion, enhancing security by leveraging the unique dynamic features of a user's facial movements and the motion of the device to prevent unauthorized access. Various embodiments require users to perform specific facial expressions or facial feature motions, making it significantly more challenging to spoof than static imaging of the user's face. The mobile device utilizes either a fast-frame-rate camera or an event-based vision sensor capable of capturing movements of facial features within microseconds.

Additionally, various embodiments introduce the concept of a “motor signature” of authorized users, which involves both facial feature movements associated with facial expressions and arm movements from moving the mobile device while imaging the face. This dual-layer security approach ensures a higher level of protection against unauthorized access than possible using conventional facial recognition methods alone. The dynamic facial feature expressions and device motion authentication process may also be combined with other authentication methods, such as fingerprint recognition or voice recognition based on words spoken while performing the facial expression and mobile device movements of the user's authentication pattern.

The embodiments overcome many of the limitations of conventional static image-based facial recognition solutions by integrating dynamic facial gestures with synchronized device motion data. For example, event-based vision sensor (EBVS) and IMU data may be used to construct spatiotemporal trajectories that represent user-specific dynamic patterns. Unlike static imaging methods, EBVS captures asynchronous changes in illumination or contrast at microsecond intervals to allow for the detection of subtle facial gestures and movements that occur over very short periods. By combining this detailed facial data with precise motion data from the IMU, the device may create a composite biometric signature that is significantly more resistant to spoofing than conventional static image-based facial recognition solutions. The combined approach may be particularly well-suited for systems that benefit from real-time authentication.

As used herein, the term “event-based vision sensor” refers to an image sensor that may detect changes in illumination or contrast at individual sensor pixels and outputs asynchronous events corresponding to the detected changes. Unlike conventional frame-based cameras that capture complete images at fixed intervals, an event-based vision sensor may generate discrete events characterized by timing, polarity, and spatial position in response to changes in input features such as pixel intensity. An event-based vision sensor may output asynchronous events with a temporal resolution of approximately one microsecond, one nanosecond, or any suitable increment of time, enabling capture of rapid movements and subtle dynamics that may not be detectable by conventional frame-based cameras. In some implementations, an event-based vision sensor may be combined with high-frame-rate imaging capabilities in a single sensor device.

As used herein, the term “inertial measurement unit” (IMU) may refer to an electronic device that measures and reports motion-related data of a body to which it is attached. An inertial measurement unit may include one or more accelerometers configured to measure linear acceleration along one or more axes, and one or more gyroscopes configured to measure angular velocity or rotational rate about one or more axes. In some implementations, an inertial measurement unit may also include one or more magnetometers to provide heading information relative to magnetic north. The data output by an inertial measurement unit may be used to determine position, orientation, velocity, and acceleration of the body, and may be processed to track changes in motion over time.

In some embodiments, the motion data may be captured from a wearable device such as a smartwatch in addition to or instead of an inertial measurement unit integrated within the mobile device. A smartwatch worn on the user's wrist may capture IMU data corresponding to arm movements during an authentication session, providing motion trajectory information that may be correlated with the dynamic facial expression data captured by the vision sensor. While smartwatches may be typically worn on the non-dominant hand, the motion patterns associated with the user's arm movements during an authentication gesture may provide distinctive biometric information. In some implementations, the smartwatch may provide additional biometric signals beyond motion data, such as an electrocardiogram (ECG) signature, which may be unique to individuals and may serve as a further authentication factor. The system may fuse data from multiple body-worn sensors to enhance authentication accuracy and security, including data from electroencephalogram (EEG) sensors, heart rate monitors, or other physiological sensors. Such sensor fusion may enable the authentication system to combine dynamic facial expression data, device motion data, and physiological signals to create a multi-modal biometric signature that is highly resistant to spoofing and uniquely associated with the authorized user.

In some embodiments, specific facial movements such as eye movements, blinking patterns, jaw movements, lip movements, eyebrow raises, and other discrete facial actions may be captured and processed as independent features that are fused with the motion signature. These individual facial movement features may be extracted from the spatiotemporal data and analyzed separately from the overall dynamic facial expression gesture. The system may track the timing, duration, frequency, and sequence of specific facial movements to generate additional biometric features that characterize the user. For example, the rate and pattern of eye blinks, the speed and extent of jaw movements during speech or expression changes, and the coordination between different facial muscle groups may provide distinctive biometric information. These independent facial movement features may be combined with the device motion signature through sensor fusion techniques to create a more comprehensive and robust biometric authentication signature. The fusion of discrete facial movement features with the motion signature may enhance authentication accuracy by providing multiple independent sources of biometric information that must collectively match those of an authorized user, thereby increasing resistance to spoofing attempts.

The word “exemplary” may be used herein to mean “serving as an example, instance, or illustration.” Any implementation described herein as “exemplary” is not necessarily to be construed as preferred or advantageous over other implementations.

The term “computing device” may be used herein to refer to any electronic device that includes memory and programmable processors capable of executing computational tasks, such as machine learning algorithms, artificial intelligence models, or other data-processing operations, to provide the described functionality. Examples of computing devices include, but are not limited to, server systems, edge computing devices, personal computers, laptops, tablets, mobile devices (e.g., smartphones), wearable devices (e.g., smartwatches, head-mounted displays), Internet of Things (IoT) devices (e.g., smart speakers, thermostats, home automation hubs), autonomous vehicles, drones, augmented or virtual reality systems, and audio-enabled devices. Computing devices may also encompass hybrid devices and modular systems designed for specific computational tasks.

The terms “mobile device” and “end-user device” may be used interchangeably and refer to electronic devices that incorporate a programmable processor and memory and are capable of wirelessly connecting to networks or other devices. Examples include smartphones, tablets, ultrabooks, wearable devices (e.g., smartwatches, fitness trackers, head-mounted displays), wireless gaming controllers, personal assistants, multimedia-enabled devices, Internet of Things (IoT) devices (e.g., smart locks, thermostats), drones, virtual reality (VR) headsets, augmented reality (AR) headsets, mixed reality (MR) headsets, and vehicles integrated with computational functionality. Variations of these devices, such as extended reality (XR) headsets and unmanned aerial vehicles (UAVs), are also encompassed by the term mobile device. While various embodiments are particularly relevant to portable or wireless devices such as smartphones and tablets, the described techniques may apply broadly to any device capable of performing the specified operations, including edge devices and augmented reality platforms.

The term “processing system” may be used herein to refer to one or more processors, including multi-core processors, that are organized and configured to perform various computing functions. Various embodiment methods may be implemented in one or more of multiple processors within a processing system of a computing device, as described herein.

The term “system on chip” (SoC) is used herein to refer to a single integrated circuit (IC) chip that contains multiple resources or independent processors integrated on a single substrate. A single SoC may contain circuitry for digital, analog, mixed-signal, and radio-frequency functions. A single SoC may include at least one processor of a processing system that includes any number of general-purpose or specialized processors (e.g., network processors, digital signal processors, modem processors, video processors, etc.), memory blocks (e.g., ROM, RAM, Flash, etc.), and resources (e.g., timers, voltage regulators, oscillators, etc.). For example, an SoC may include an applications processor that operates as the SoC's main processor, central processing unit (CPU), microprocessor unit (MPU), arithmetic logic unit (ALU), etc. An SoC processing system may also include software for controlling integrated resources and processors, as well as for controlling peripheral devices.

The term “neural network” may be used herein to refer to an interconnected group of processing nodes (or neuron models) that collectively operate as a software application or process that controls a function of a computing device and/or generates an overall inference result as output. Individual nodes in a neural network may attempt to emulate biological neurons by receiving input data, performing simple operations on the input data to generate output data, and passing the output data (also called “activation”) to the next node in the network. Each node may be associated with weight and/or parameter values, that define or govern the relationship between input data and output data. A neural network may learn to perform new tasks over time by adjusting these weight and/or parameter values. Weights and/or parameters of the neural network(s) or system(s) are, therein, refer to as weights to simplify the presentation. In some cases, the overall structure of the neural network and/or the operations of the processing nodes do not change as the neural network learns a task. Rather, learning is accomplished during a “training” process in which the values of the weights in each layer are determined. As an example, the training process may include causing the neural network to process a task for which an expected/desired output is known, comparing the activations generated by the neural network to the expected/desired output, and determining the values of the weights in each layer based on the comparison results. After the training process is complete, the neural network may begin “inference” to process a new task with the determined weights.

The terms “machine learning algorithm” and “artificial intelligence model” and the like may be used interchangeably herein to refer to a variety of computational models or information structures that may be used by a computing device to perform tasks, computations, or evaluations. Examples of machine learning algorithms include neural network models, inference models, classifiers, random forest models, spiking neural network (SNN) models, convolutional neural network (CNN) models, recurrent neural network (RNN) models, state-space models (SSMs), deep neural network (DNN) models, generative adversarial networks (GANs), ensemble networks, and genetic algorithm models. In some embodiments, a machine learning algorithm may include an architectural definition (e.g., neural network architecture) and corresponding weights (e.g., neural network weights).

The term “inference” may be used herein to refer to a process that is performed at runtime or during the execution of the software application program corresponding to the machine learning algorithm. Inference may include traversing the processing nodes in a network (e.g., neural network, etc.) along a forward path (which may include some backward traversals) to produce one or more values as an overall activation or overall “inference result.”

The terms “gesture” and “authentication gesture” are used herein as shorthand references to the patterns of facial feature movements during expression changes and motions of the mobile device while imaging the user's face that are recorded or trained by authorized users and then repeated during a user authentication process.

Conventional systems for providing facial recognition authentication of users typically involve using a camera to capture an image of the user's face, which is then analyzed and compared to a stored facial feature template to verify the user's identity. Despite its effectiveness, there are concerns about the potential for spoofing of facial recognition solutions, such as using a 3D model of a head and a picture of the user to trick the system.

Some embodiments may include a mobile device configured to overcome limitations of conventional facial recognition systems by processing dynamic facial expression gestures in conjunction with correlated motions captured by an event-based vision sensor (EBVS). The mobile device may use EBVS technology to detect illumination or contrast changes at individual pixels and output asynchronous events with microsecond temporal resolution. By pairing EBVS data with inertial measurement unit (IMU) data, the mobile device may construct spatiotemporal trajectories that represent dynamic facial gestures and device motions. These trajectories may enhance security and accuracy by leveraging high-frequency, low-latency data to identify unique biometric patterns that are highly resistant to spoofing. In some embodiments, the mobile device may also integrate additional authentication techniques to improve reliability.

In some embodiments, the mobile device may be equipped with an EBVS, a high-frame-rate camera, or a sensor that combines both event-based sensing and high-frame-rate imaging. The EBVS may capture sparse, dynamic data effectively in low-light or high-motion scenarios, whereas the high-frame-rate camera may provide additional flexibility for applications requiring color or detailed image frames. Some vision sensors are capable of both event-based sensing and high-frame-rate imaging, so in embodiments using such sensors, the processing system of the mobile device may select one or both sensor data streams for processing according to the embodiments described herein. The EBVS, high-frame-rate camera, or event-based sensing and high-frame-rate imaging sensor may be configured to process light within a wide range of frequencies, including non-visible light such as infrared and/or ultraviolet light. For example, such vision sensors may be combined with an infrared light source to illuminate the user's face during an authentication scan with light invisible to the user. Infrared vision sensors may be configured to image in the near infrared, short-wave infrared, mid-wave infrared and/or long-wave infrared (thermal).

To initiate authentication, the mobile device may prompt the user to perform specific facial expressions while simultaneously moving the device. The mobile device may capture facial feature movements using an EBVS or high-frame-rate camera to record spatiotemporal data with high temporal resolution. Simultaneously, the mobile device may use its IMU to capture motion data that allows the device to associate device movement with dynamic facial expressions and generate a unique biometric signature. During authentication, the mobile device may process spatiotemporal data of facial features alongside IMU motion data to construct a composite trajectory that represents the dynamic interplay between facial expressions and device movements to generate a robust biometric signature.

In some embodiments, the facial features and facial movements of the user may be captured using radio frequency (RF) and/or radar signaling in addition to or instead of optical vision sensors. RF and radar-based sensing may detect facial movements by transmitting electromagnetic signals toward the user's face and analyzing the reflected signals to identify changes in position, shape, and motion of facial features. Such RF or radar-based sensing may operate in various frequency bands, including millimeter-wave frequencies, and may provide advantages in certain conditions where optical sensors may be limited, such as low-light environments or situations where the user is wearing eyeglasses or other accessories that may interfere with optical sensing. Radar-based facial sensing may capture micro-movements of facial muscles, subtle skin vibrations associated with expressions, and three-dimensional depth information about the user's face. In some implementations, RF or radar sensing may be combined with optical vision sensors to provide a multi-modal sensing approach that enhances the robustness and accuracy of the dynamic facial expression capture. The spatiotemporal data derived from RF or radar signals may be processed in a manner similar to data from optical sensors, enabling the construction of composite spatiotemporal trajectories that represent the dynamic interplay between facial expressions and device movements during an authentication session. In some embodiments, biometric signatures derived from RF or radar channels may be added to or substituted for event-based vision sensor signals to provide alternative or complementary sensing modalities. Motion-induced frequency changes, such as Doppler effects observed in reflected RF or radar signals, may be relevant for capturing facial movements and device motion, as the frequency shifts may correspond to the velocity and direction of moving facial features or the mobile device itself.

As used herein, the term “composite trajectory” or “spatiotemporal trajectory” or “composite spatiotemporal trajectory” may refer to a data structure that represents the combined spatiotemporal movements of a user's facial features together with motion data from a mobile device. A composite trajectory may be constructed by combining spatiotemporal data captured via a vision sensor, such as an event-based vision sensor or high-frame-rate camera, with motion data captured via an inertial measurement unit. The composite trajectory may represent the dynamic interplay between facial expressions and device movements over time, capturing both the temporal progression of facial feature changes and the corresponding position, orientation, and motion of the mobile device during an authentication session. A composite trajectory may be compared to stored templates or processed by a neural network to determine whether the combined facial dynamics and device motion match those of an authorized user.

In some embodiments, the mobile device may preprocess vision and IMU data streams to remove noise and inconsistencies while preserving temporal resolution. The mobile device may combine spatiotemporal and motion data to construct composite spatiotemporal feature trajectories representing dynamic facial movements and device motion. These trajectories may be compared to stored biometric templates of authorized users. The mobile device may use advanced algorithms, such as neural networks trained on spatiotemporal trajectories, to determine whether the constructed trajectory aligns with the stored template within a predefined threshold. This threshold may be dynamically adjusted based on environmental factors, including lighting conditions and the device's orientation, to enhance accuracy under varying conditions.

In some embodiments, the mobile device may use EBVS technology to detect and process dynamic facial expressions without capturing or storing full facial images. Instead, the mobile device may analyze sparse event-based data from specific facial features, such as the user's eyes or lips, to authenticate the user. These privacy-preserving features may allow the mobile device to comply with stringent data protection regulations while maintaining robust security for sensitive applications.

As used herein, the term “sparse spatiotemporal event-based data” may refer to data captured by an event-based vision sensor that represents changes in illumination or contrast at discrete spatial locations and times, rather than dense image frames capturing all pixels at regular intervals. Sparse spatiotemporal event-based data may be limited to particular facial features and facial expressions, such as the user's eyes, lips, eyebrows, and facial muscles in the cheeks or forehead, without capturing complete images of the user's face. This sparse data may provide sufficient information to enable recognizing a user-specific facial feature expression gesture or signature while preserving user privacy by not recording full facial images. Sparse spatiotemporal event-based data may be matched to a previously generated and/or stored dynamical trajectories of facial features related to facial expression gestures, mobile device movements, or both combined.

In some embodiments, the mobile device may process sparse spatiotemporal data related to facial expressions and device movements to recognize micro-expressions and other subtle facial dynamics, the mobile device may detect spoofing attempts by analyzing the spatiotemporal and IMU data streams to identify inconsistencies in temporal dynamics or spatial distortions. The mobile device may initiate protective actions to safeguard the protected asset or secure operation in response to detecting a spoofing attempt.

In some embodiments, the mobile device may use a trained neural network to analyze dynamic facial expressions and device motion data captured during authentication. By capturing spatiotemporal data through an EBVS or high-frame-rate camera, the mobile device may process facial feature movements while simultaneously recording motion data through the IMU. The mobile device may evaluate whether the combined spatiotemporal and motion data matches stored biometric patterns of an authorized user performing the same authentication gestures. The mobile device may grant access to a protected asset or operation in response to determining that the neural network infers a match.

In some embodiments, the mobile device may incorporate a neural network capable of real-time processing of spatiotemporal data. For event-based data, the mobile device may use specialized neural network processes configured for high-frequency, low-latency analysis. The mobile device may analyze the temporal progression of facial movements to enhance inference accuracy when processing frame-based data.

During training sessions, the mobile device may capture spatiotemporal data of facial feature movements and motion data while prompting the user to perform predefined facial gestures and device motions. The mobile device may use this data to train or fine-tune the neural network so that it may more accurately associate these patterns with the user's biometric signature.

In some embodiments, to further enhance performance, the mobile device may include or integrate the vision sensor, IMU, with a neural processing unit (NPU) in a single circuit assembly. This integration may allow the mobile device to perform real-time data capture and processing for improved compactness and efficiency in the authentication system.

In some embodiments, the mobile device may further enhance security by integrating additional authentication methods, such as fingerprint or voiceprint verification, facial recognition, or two-factor authentication. In some embodiments, the mobile device may reconstruct a three-dimensional model of the user's face using captured spatiotemporal and motion data to provide an additional layer of authentication analysis and a visual record of user authentication attempts. The mobile device may also update stored biometric templates (e.g., templates of three-dimensional models of a face of a user) over time based on verified authentication events to adapt to changes in the user's facial features while maintaining reliability.

In some embodiments, the mobile device and authentication system may authenticate users solely based on dynamic facial expressions observed during an authentication scan of the user's face lasting a few seconds. By having the user change expressions or make different faces during the authentication scan, such embodiments provide improved security over systems that rely solely on static facial recognition. The particular shifting of expressions by the user may be like a password that the user selects and provides to the authentication system in an initial setup procedure, enabling the user to select an unpredictable sequence of facial feature movements for his/her dynamic facial feature gesture signature. While such embodiments may provide less protection against spoofing than embodiments that also consider IMU data, such embodiments may be appropriate for applications requiring a lower level of security, such as accessing a smartphone compared to the security appropriate for opening a banking application.

In embodiments that authenticate users solely based on dynamic facial expressions observed during an authentication scan of the user's face, the vision sensor need not be provided in a mobile device as the movements creating the biometric gesture signature are limited to facial features. Therefore, such embodiments may be implemented using fixed imaging sensors, such as in a facial scanner, a desktop computer, laptop computer, or similar non-mobile computing device or vision sensor. For ease of reference, the vision-based sensor is referred to a being contained within a mobile device; however, for embodiments authenticating based solely on dynamic facial expressions, the term “mobile device” is intended and should be interpreted to include computing devices and vision sensors that do not move during the authentication scan.

In some embodiments, the mobile device and authentication system may rely entirely on IMU data for user authentication. For example, the system may analyze motion patterns alone to derive unique biometric signatures that can be compared to motion-based biometric signatures associated with authorized users.

Authenticated users may use the mobile device to access secured systems, retrieve protected files, authorize transactions, or control vehicles. These capabilities make the mobile device a secure, efficient, and adaptable solution for high-value or high-risk scenarios.

By leveraging dynamic motion analysis and facial expression recognition, the mobile device may improve user authentication methods for granting secure access to protected resources and operations. The mobile device may implement improved authentication methods that allow for secure access to IoT-connected devices, high-security facilities, and financial systems. The mobile device may allow authenticated users to unlock the device, initiate secure transactions, or control IoT systems such as smart home locks or industrial equipment. The mobile device may combine dynamic facial gestures with device motion to provide versatile, high-security solutions for diverse applications.

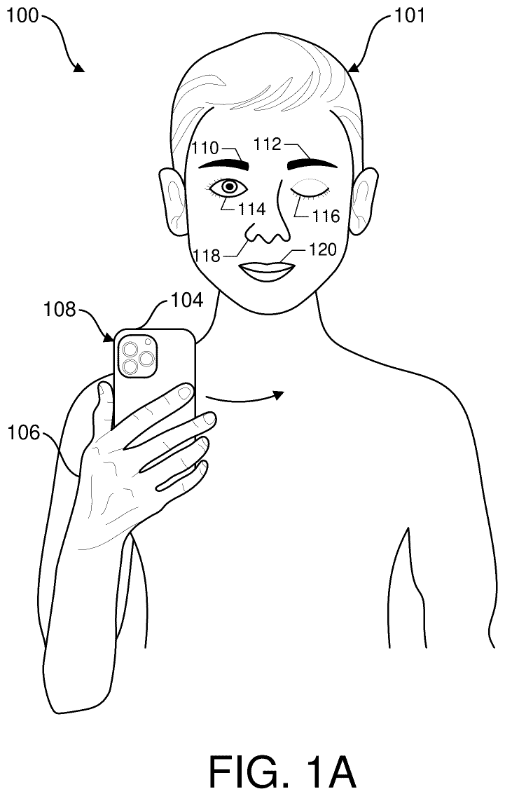

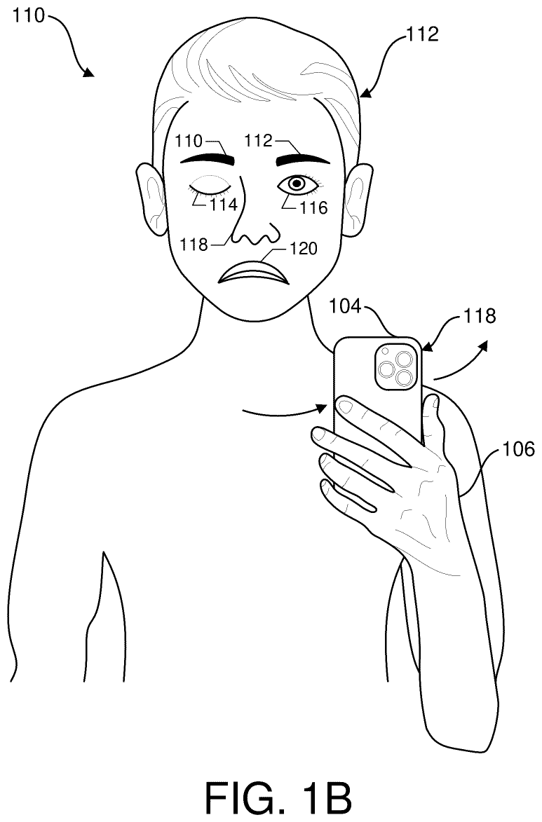

FIGS. 1A and 1B illustrate two instances in a facial expression plus mobile device motion biometric signature user authentication session. FIG. 1A illustrates an initial stage of a dynamic facial expression and device motion gesture performed by a user 101. In this figure, the user 101 holds a smartphone device 104, initiating a unique identifying sequence that involves changes in facial expressions synchronized with device motion as the user moves the smartphone device through a selected motion, such as from one side of the face to the other. At the start of the authentication session, the user's right eye 114 is open, and the left eye 116 is closed, while the lips 120 are in a smiling expression. Notably, certain facial features, such as the eyebrows 110, 112 and the nose 118, remain unchanged, serving as consistent reference points throughout the authentication session. This starting configuration of facial features, in conjunction with the initial motion data of the smartphone device 104, forms part of the biometric signature uniquely associated with the user 101. The event-based vision sensor, high-frame-rate imaging system, or a sensor that combines both event-based sensing and high-frame-rate imaging sensor captures this initial configuration as spatiotemporal data, which is processed alongside inertial motion data from the device.

FIG. 1B depicts the concluding stage of the dynamic facial expression and device motion gesture initiated in FIG. 1A. By the end of the authentication session, the user 101 has transitioned to a different facial expression in which the left eye 116 is open, and the right eye 114 is closed, while the lips 120 now form a frowning expression. As in FIG. 1A, the eyebrows 110, 112 and the nose 118 remain unchanged, providing stable reference points for spatiotemporal data processing. This transition from the starting expression in FIG. 1A to the concluding expression in FIG. 1B, synchronized with the corresponding motion of the smartphone device 104, creates a unique dynamic biometric signature for the user 101. The changes in facial expressions, combined with the smartphone's motion trajectory, are captured and processed to verify the identity of the user.

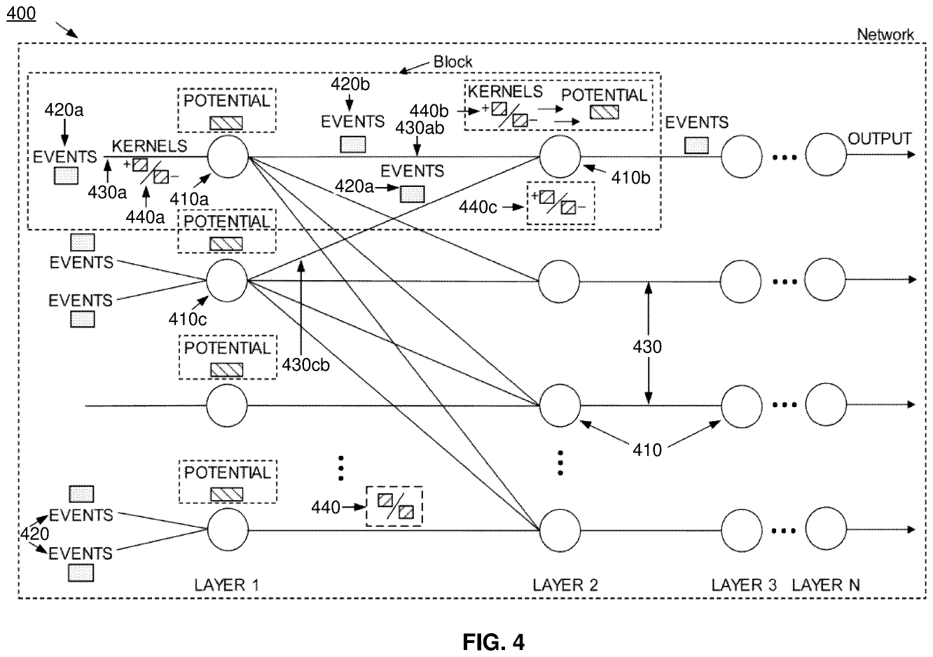

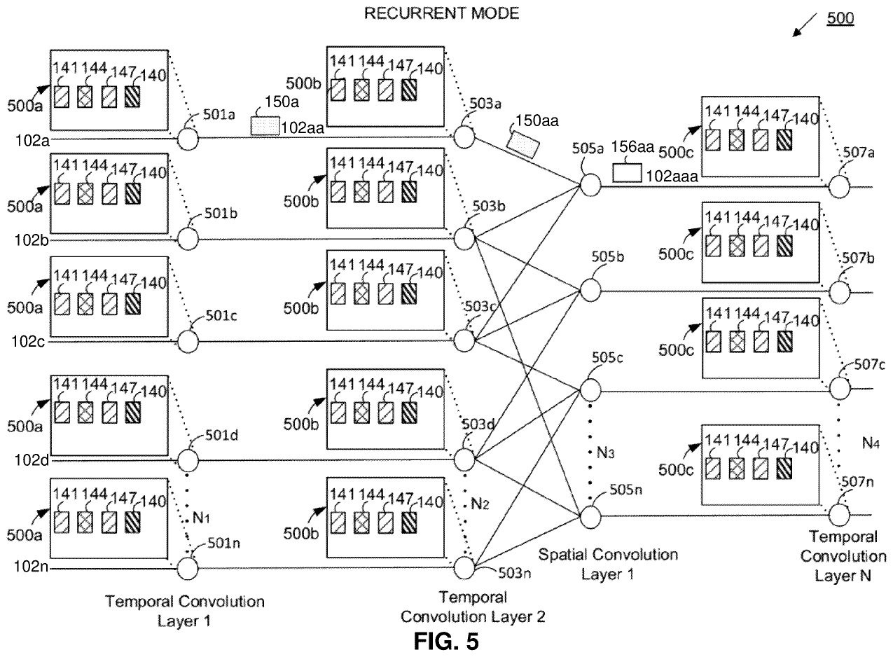

The combination of the dynamic changes in the user's facial expressions and the synchronized motion of the smartphone 104 provides a highly distinctive and personalized signature that can be matched to stored or trained authentication gestures of authorized users. Rapid image capture, processing and recognition/comparison of facial features and device location information enable the method to leverage both facial dynamics and device movement to provide reliable user-specific biometric authentication. Such rapid capture, processing and recognition/comparison of facial features and device location information may be accomplished be capturing facial feature image data with an event-based image processor or fast frame-rate camera and processing the image data using a trained neural network that implements processing methods capable of processing and inferring from high-data rate spatiotemporal data streams as described herein with reference to FIGS. 4 and 5.

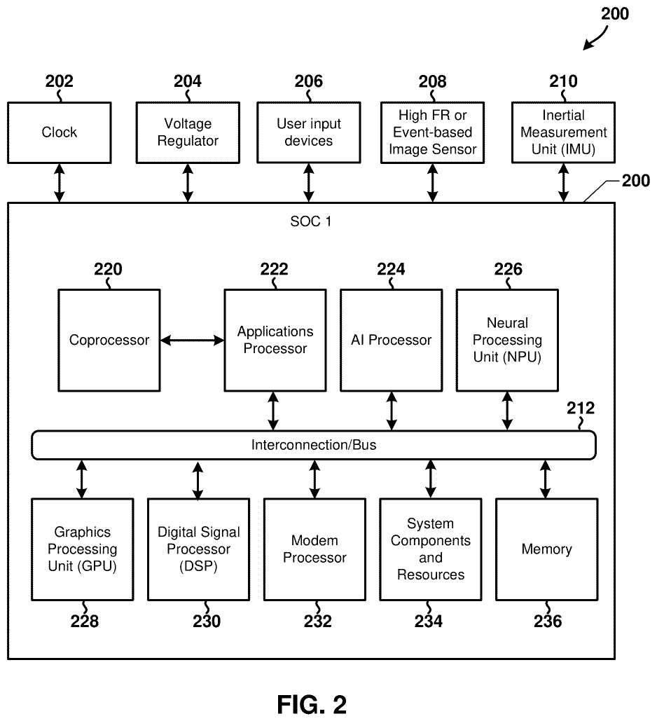

Various embodiments may be implemented in single-processor or multiprocessor computer systems, including a system-on-chip (SoC). FIG. 2 illustrates an example computing system or SoC 200 architecture that may be included in edge devices implementing the various embodiments.

In the example illustrated in FIG. 2, the SoC 200 includes a clock 202, voltage regulator 204, and user input devices 206 (e.g., touch-sensitive displays, microphones, cameras). The SoC 200 integrates various processors, including a coprocessor 220 (e.g., vector coprocessor), applications processor 222, AI processor 224, and neural processing unit (NPU) 226. Additional components include the graphics processing unit (GPU) 228, digital signal processor (DSP) 230, modem processor 232, memory 236, and system components and resources 234. The processors and components may be interconnected via an interconnection/bus 212, which may utilize advanced interconnect technologies such as high-performance networks-on-chip (NoCs), reconfigurable logic arrays, or bus architectures like CoreConnect or AMBA.

In some embodiments, any of the processors 220-232 in the SoC 200 may function as the central processing unit (CPU), microprocessor unit (MPU), or arithmetic logic unit (ALU). The SoC 200 may execute software programs, performing arithmetic, logical, control, and input/output (I/O) operations as specified by program instructions (e.g., processor-executable instructions, etc.). One or more of the coprocessors 220 may be configured to assist the CPU in these operations.

Each processor 220-232 may include one or more cores, and each processor/core may perform operations independent of the other processors/cores. For example, the SOC 200 may include a processor that executes a first type of operating system (e.g., FreeBSD, LINUX, etc.) and a processor that executes a second type of operating system (e.g., OS X, etc.).

In some embodiments, any or all of the processors 220-232 may be part of a processing cluster, such as a heterogeneous processor cluster architecture. In some embodiments, any or all of the processors 220-232 may operate as part of CPU clusters, with interconnected nodes (e.g., cores, processors, SoCs) working in coordination to perform computational tasks. Each node may have its own operating system, CPU, memory, and storage. A computational task may be divided among these nodes, allowing for parallel processing. The results from each node's computation may be combined to produce a final result (often faster compared to a single processor). CPU clusters also offer greater reliability and resilience to failure due to their distributed nature.

The SoC 200 includes various system components and resources for managing sensor data, wireless transmissions, analog-to-digital conversions, and other specialized tasks, such as performing AI inference or precomputing hidden states for frequently used input text. These components may include power amplifiers, voltage regulators, oscillators, phase-locked loops, data controllers, memory controllers, and peripheral bridges. The system components also facilitate communication with peripheral devices such as cameras, microphones, external displays, and wireless communication modules.

The SoC 200 may further include an input/output (I/O) module (not shown) for interfacing with external resources such as the clock 202, voltage regulator 204, user input devices 206, and wireless transceivers (e.g., Bluetooth, cellular transceivers), event-based vision sensor, high-frame-rate camera, or a sensor that combines both event-based sensing and high-frame-rate imaging 208, and an inertial measurement unit (IMU) 210. These external resources may be shared among multiple processors or cores within the SoC 200.

In addition to the SoC 200, various embodiments may be implemented in other computing systems, including those with single or multicore processors, multiple processors, or hybrid configurations that integrate different processing technologies.

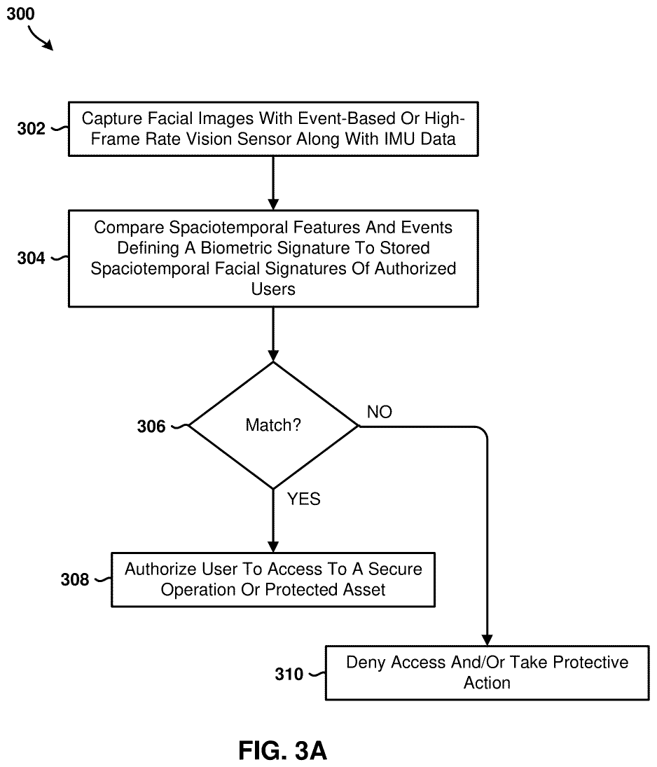

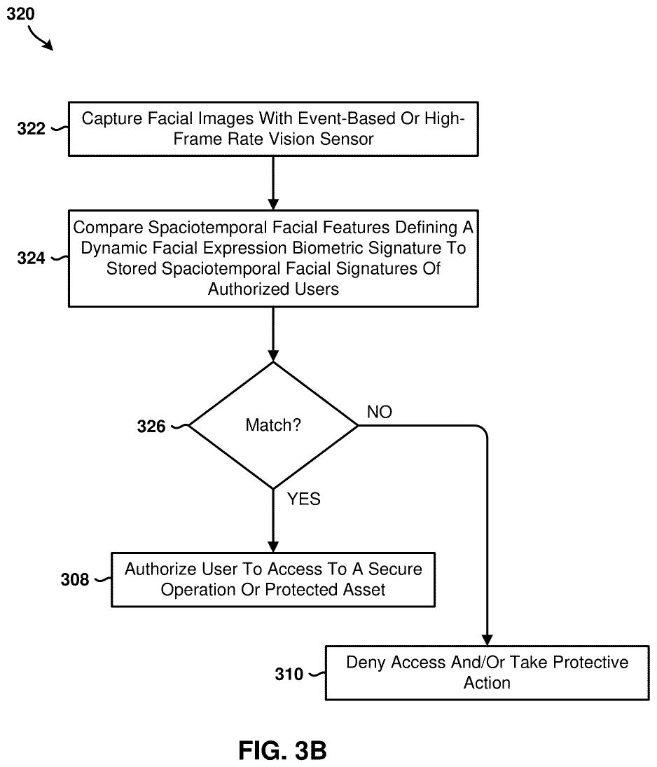

The flow diagram in FIG. 3A provides an overview of a method 300 for secure biometric authentication using dynamic facial expression gestures and mobile device movements according to some embodiments. The method 300 may be performed by a mobile device (e.g., a smartphone device 104) by a processing system encompassing one or more processors (e.g., processors 220-232, etc.), components, or subsystems discussed in this application. In some embodiments, the processing system may perform all of the operations internally. In some embodiments, the processing system may access remote services or databases to complete some operations as described For ease of reference, the components of the computing device involved in performing method operations are referred to generally as a “processing system.”

In block 302, the processing system may capture facial images with an event-based, high frame rate vision sensor, or a sensor that combines both event-based sensing and high-frame-rate imaging along with IMU data of movements of the mobile device. This data may be processed as spatiotemporal data that captures dynamic facial movements synchronized with the motion data captured via the IMU integrated within the mobile device. The vision sensor records changes in illumination or contrast to create asynchronous events or high-resolution image frames that represent the user's facial expression gestures. Simultaneously, the IMU records the motion dynamics of the mobile device, which are crucial for reconstructing the composite trajectory of both facial movements and device motion.

In block 304, the processing system may process the captured spatiotemporal data and compare recognized dynamic facial features and device movements against stored or trained facial features and device movement gesture signatures associated with authorized users or designated as associated with authorized users. These operations may include extracting biometric patterns or signatures from the captured data and aligning them with previously stored or trained authorization gesture templates or data sequences of authorized users. The processing and comparison operations may be performed in a neural network model trained and capable of analyzing the dynamic interplay between facial expressions and device movements to recognize unique biometric signatures based on the combination of these dynamic features, and to determine compare the dynamic facial biometric signature to stored or trained facial authorization gestures of authorized users. As described below with reference to FIGS. 4 and 5, the neural network may use advanced processing techniques capable of processing high frame rate spatiotemporal data streams to efficiently analyze and match the observed dynamic facial features and device motions to stored or trained authorized user biometric signatures.

In determination block 306, the processing system determines whether the extracted biometric signature matches a stored or trained authorized user biometric signature/authentication gesture. As dynamic movements and facial expressions will vary from instance-to-instance, the determination in block 306 may involve determining whether there is a match within a predefined threshold value of similarity or match beyond a predefined threshold value of a similarity measure (e.g., percentage similarity), such as an inference of a match within a predetermined probability. This threshold may be dynamically adjustable based on environmental factors, such as lighting conditions and device orientation, to ensure reliable operations under varying circumstances.

In response to determining that the extracted biometric signature matches a stored or trained authorized user biometric signature (i.e., determination block 306=“YES”), the processing system may authorize the user to perform a secure operation or access a protected asset in block 308. Non-limiting examples of operations and assets that may be protected by the method 300 and enabled in block 308 include activation or use of the mobile device itself, access to a protected network by the mobile device, access to a file or database stored in the mobile device (e.g., personal information) or in memory maintained in an accessed network, activation or use of another device (e.g., another computing device, an automobile, an aircraft, etc.), physical access to a locked structure (e.g., unlocking a door to a locked facility, opening a safe), authorizing a transaction (e.g., transferring money, buy or selling an asset, etc.) and/or initiating communications with a protected individual or enterprise. Other applications of the method 300 for authorizing a secure operation or accessing a protected asset are contemplated in various embodiments.

In response to determining that extracted biometric signature does not match a stored or trained authorized user biometric signature (i.e., determination block 306=“NO”), the processing system may deny access to the protected asset in block 310. In some embodiments the processing system may also take or initiate one or more protective actions. Such protective actions may include, but are not limited to, generating an alert, locking the mobile device, and/or triggering additional security measures to safeguard the protected asset. In some embodiments, the processing system may analyze the captured spatiotemporal data to detect or recognize potential spoofing attempts based on temporal or spatial inconsistencies in the input data, which may enable the system to implement additional security measures in the authentication process.

In some embodiments, user authentication may be based solely on a dynamic facial expression gesture in which the user changes expressions (makes different faces) during a brief authentication scan of the user's face. Such embodiments may be useful in applications in which lower certainty in user authentication is acceptable, such as accessing low-risk assets or services. The flow diagram in FIG. 3B provides an overview of such a method 320 for secure biometric authentication using dynamic facial expression gestures according to some embodiments. The method 320 may be performed by a mobile device (e.g., a smartphone device 104) by a processing system encompassing one or more processors (e.g., processors 220-232, etc.), components, or subsystems discussed in this application. In some embodiments, the processing system may perform all of the operations internally. In some embodiments, the processing system may access remote services or databases to complete some operations as described For ease of reference, the components of the computing device involved in performing method operations are referred to generally as a “processing system.”

In block 322, the processing system may capture a series of facial images with an event-based, high frame rate vision sensor, or a sensor that combines both event-based sensing and high-frame-rate imaging. This data may be processed as spatiotemporal data that captures dynamic facial movements of the user's changing expressions. The vision sensor records changes in illumination or contrast to create asynchronous events or high-resolution image frames that represent the user's facial expression gestures.

In block 324, the processing system may process the captured spatiotemporal data of dynamic facial expressions and compare recognized dynamic facial features against stored or trained dynamic facial feature gesture signatures associated with authorized users. These operations may include extracting biometric patterns or signatures from the captured data and aligning them with previously stored or trained authorization gesture templates or data sequences of authorized users. The processing and comparison operations may be performed in a neural network model trained and capable of analyzing dynamic facial expressions to recognize unique biometric signatures and compare the dynamic facial biometric signature to stored or trained facial authorization gestures of authorized users. As described below with reference to FIGS. 4 and 5, the neural network may use advanced processing techniques capable of processing high frame rate spatiotemporal data streams to efficiently analyze and match the observed dynamic facial features to stored or trained authorized user biometric signatures.

In determination block 326, the processing system determines whether the extracted dynamic facial expression biometric signature matches a stored or trained authorized user biometric signature/authentication gesture. As facial expressions will vary from instance-to-instance, the determination in block 326 may involve determining whether there is a match within a predefined threshold, such as an inference of a match within a predetermined probability. This threshold may be dynamically adjustable based on environmental factors, such as lighting conditions and device orientation, to ensure reliable operations under varying circumstances.

In response to determining that the extracted biometric signature matches a stored or trained authorized user biometric signature (i.e., determination block 326=“YES”), the processing system may authorize the user to perform a secure operation or access a protected asset in block 308 as described with reference to FIG. 3A.

In response to determining that extracted biometric signature does not match a stored or trained authorized user biometric signature (i.e., determination block 326=“NO”), the processing system may deny access to the protected asset in block 310 as described with reference to FIG. 3A.

FIG. 4 is a block diagram illustrating a first type of neural network processing method, referred to herein as PLEIADES (PoLynomial Expansions In Adaptive Distributed Event-based Systems), that may be used in some embodiments. The disclosed methodology for processing event-based data is implemented in a neural network designed to dynamically process spatial, temporal, and spatiotemporal inputs using adaptive kernels. The neural network implementing PLEIADES processing includes multiple layers, as depicted in FIG. 4, with each layer consisting of a plurality of neurons 410. These neurons are interconnected through a network of event-based connections 430, each configured to transmit discrete events characterized by timing, polarity, and spatial position. The events are generated either by event-based vision sensors or by neurons in the preceding layers of the network.

Each neuron (e.g., 410a, 410b) receives events 420 over its corresponding connections (e.g., 430a, 430b). These events are associated with spatiotemporal kernels 440 stored in memory. The kernels may include at least a first kernel (positive kernel) and a second kernel (negative kernel), which adaptively process events based on their polarity. For example, a positive event may activate the first kernel, while a negative event may activate the second kernel. Each kernel is configured to offset dynamically in spatial, temporal, or spatiotemporal dimensions to account for the event's characteristics, such as its time of occurrence or the spatial location of the neuron generating the event.

The PLEIADES neural network 400 illustrated in FIG. 4 includes layers 1 through N, in which each layer processes corresponding portions of event-based data. In the first layer, neurons 410 receive data directly from an event-based sensor, such as a dynamic vision sensor (DVS), which generates events in response to changes in input features (e.g., changes in pixel intensity). The events propagate through the network via the connections 430 to neurons in subsequent layers. Each connection is associated with spatiotemporal kernels 440, which define how the events influence the receiving neuron.

For example, a neuron 410b in layer 2 may receive events 420b over a connection 430ab from a neuron 410a in layer 1. These events are characterized by their polarity, spatial position (pₖ, qₖ), and temporal attributes (tₖ). The kernels 440b associated with the connection 430ab are offset dynamically based on these attributes. In particular, the offset involves aligning the kernels with the event's spatial and temporal dimensions, enabling the neuron to calculate its potential dynamically. The potential of a neuron, u(x, y, t), at position (x, y) in the network at time t, is determined by summing the contributions of all kernels associated with received events, as defined by equation:

$$u ( x , y , t ) = {\sum }_{k} h ( x - {p}_{k} , y - {q}_{k} , t - {t}_{k} )$$

where h(·) represents the spatiotemporal kernel, and pₖ, qₖ, tₖ are the polarities and spatial and temporal coordinates of the events generated by the neurons projecting to that one neuron. That is, pₖ and qₖ may correspond to spatial coordinates and tₖ may correspond to a temporal coordinate of the k^{th} event, and the polarity of the k^{th} event may be represented separately (e.g., by an additional polarity variable) or implicitly by selecting a corresponding polarity-specific kernel for inclusion in the sum. The output may be obtained by passing the neuron potential through a nonlinearity, which may, if going above a positive, or below a negative threshold, generate at the neuron's output a positive or negative event, respectively.

As shown in FIG. 4, connections may link a neuron (e.g., 410b) to multiple preceding neurons (e.g., 410a and 410c). The neuron 410b calculates its potential by summing the offset kernels corresponding to all events received from these connections over a period of time, or over all times. For instance, when neuron 410a sends multiple events (e.g., positive and negative), the associated kernels 440b are offset and summed in spatiotemporal dimensions to determine the potential. Similarly, events received from neuron 410c via connection 430cb are processed through kernels 440c), with the combined contributions updating the potential dynamically.

The PLEIADES architecture shown in FIG. 4 enables efficient processing of event-based data, with neurons updating their potentials only when new events are received. This event-driven mechanism significantly reduces power consumption and computation, as the network avoids continuous potential recalculations. Moreover, the use of kernel expansions over basis functions, such as orthogonal polynomials, allows for efficient and compact representation of kernel dynamics, further enhancing processing speed and adaptability.

Each layer in the network leverages these principles to propagate event-driven outputs to subsequent layers, enabling the neural network to efficiently capture and process spatiotemporal patterns in real-time data. For example, a neuron in a deeper layer (e.g., layer N) may receive a combination of processed outputs from neurons in preceding layers, applying its kernels to further refine the spatiotemporal transformation and representation of the input data.

The PLEIADES processing architecture illustrated in FIG. 4 and described above is well-suited for applications involving continuous temporal data, such as video streams or sensor data. The spatiotemporal offsetting of kernels ensures accurate and efficient computation of neuron potentials, supporting high-performance applications such as real-time image processing and temporal data analysis.

FIG. 5 is a block diagram illustrating a second type neural network processing method 500, referred to herein as Binned PLEIADES, that may be used in some embodiments. Binned PLEIADES processing of the spatiotemporal data and motion data looks at multiple frames, or bins (time bins), in the past to perform dynamic facial expression gesture analyses and inference by implementing a spatiotemporal neural network 500 configured to process temporal and spatial data using a combination of recurrent and convolutional operations. As illustrated in FIG. 5, a neural network performing Binned PLEIADES processing includes temporal convolution layers (e.g., 501a-501n, 503a-503n, and 507a-507n) and spatial convolution layers (e.g., 505a-505n) that sequentially process temporal and spatial features in operations in blocks 500a, 500b, 500c, etc. This architecture is particularly efficient for edge computing, enabling the system to perform real-time inference with reduced computational and memory requirements.

Each temporal convolution layer includes a plurality of neurons (e.g., 501a-501n performing operations 500a) in which each neuron is associated with a memory vector 140 that stores a compressed representation of past inputs, referred to as the “internal state.” Temporal kernels in these layers are represented as polynomial expansions, enabling efficient representation of kernel parameters. This representation minimizes the number of parameters needed while maintaining a high temporal receptive field.

The Binned PLEIADES processing methodology in recurrent mode begins with the receipt of sequential input data 102a-102n at the temporal convolution layers. For each time step, the system updates the internal state of each neuron by performing two key operations. First, the input data is projected into a coefficient space using a reference matrix 141. Second, the current internal state 140 is transformed via a matrix multiplication with a state operator 144 and then updated by adding the projected input. This updated memory vector becomes the internal state 140 for the next time step.

To produce outputs, the system computes a dot product between the updated memory vector and temporal kernel coefficients 147. This recurrent processing methodology effectively performs a temporal convolution in the coefficient space, avoiding the need to explicitly compute or store full kernel and input values. The resulting scalar output represents the processed temporal features at each neuron. Nonlinear activation functions may then be applied to the scalar outputs to introduce nonlinearity before passing the outputs to subsequent layers.

The outputs of the temporal convolution layers are passed to the spatial convolution layers (e.g., 505a-505n), where spatial features are extracted using spatial kernels. These spatial kernels combine inputs from multiple neurons to produce spatially convoluted outputs. The spatial processing is followed by additional temporal and spatial convolutions, enabling hierarchical extraction of spatiotemporal features across the network.

The use of polynomial expansions to represent temporal kernels provides several advantages, including compact parameter storage, efficient training, and robustness to non-uniformly sampled temporal data. This configuration also allows the network to maintain low latency by performing linear operations in the recurrent layers while leveraging hierarchical spatiotemporal processing.

The Binned PLEIADES processing architecture illustrated in FIG. 5 and described above is well-suited for applications involving continuous temporal data, such as video streams or sensor data. The recurrent mode enables efficient online processing while reducing memory overhead, making it ideal for edge device implementations.

Instead of the recurrent mode, the buffer mode may also be used as disclosed in PCT application publication WO 2023/250093 A1 that is attached as Appendix B.

Instead of performing a convolution of the kernels with the inputs as in Binned PLEIADES buffer and recurrent modes, a projection of the input(s) onto related basis function(s) as in a PLEIADES Transform.

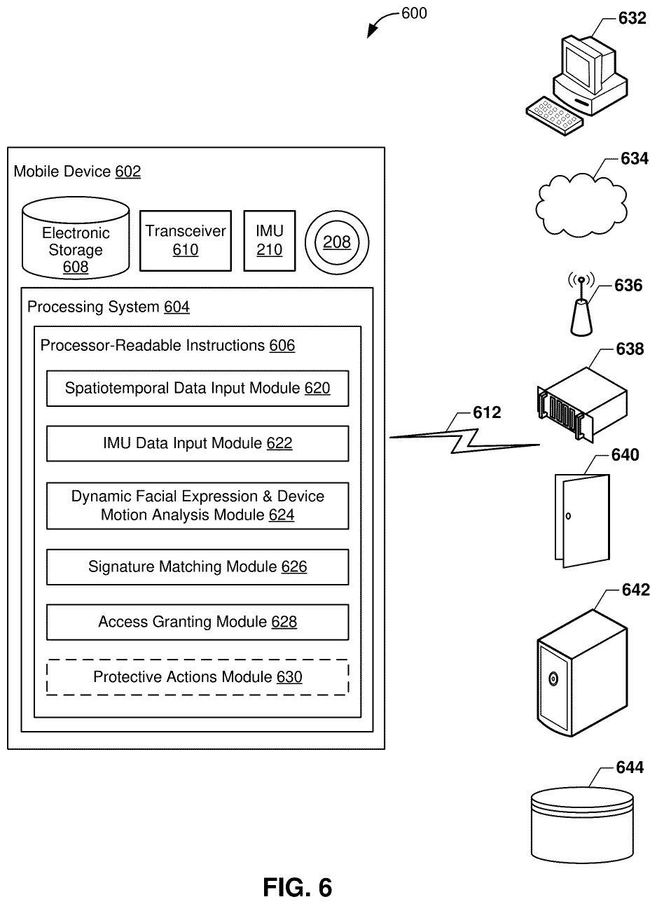

FIG. 6 illustrates a block diagram of a user authentication system 600 configured to implement the processes of various embodiments. With reference to FIGS. 1A-6, the user authentication system 600 includes a mobile device 602 (e.g., 104) configured to perform methods of various embodiments to grant use or access to secure operations and protected assets to authorized users. The user authentication system 600 provides secure user authentication processes useful for protecting various secure or protected assets, such as the mobile device 602, another computing system or device 632, secure networks 634, wireless access points 636, secure servers 638, secure facilities (e.g., opening locked doors 640), opening safes 642 (or similar locked vaults or equipment), and accessing secure databases 644, to name just a sampling of applications of various embodiments.

The mobile device 602 may include a processing system 604 that is coupled to electronic storage 608, a transceiver 610, an IMU 210, and a vision sensor 208, which may be an event-based vision sensor, a high frame-rate camera, or a sensor that combines both event-based sensing and high-frame-rate imaging. The processing system 604 may be configured with processor-readable instructions 606 that may be stored in non-transitory processor-readable electronic storage 608 until loaded into the processing system 604 for execution. The processing system 604 may include or be configured with one or more neural network models that are trained or fine-tuned to perform the operations of various embodiments. In some embodiments, the processing system 604 may include a neural network processing unit (NPU) or graphics processing unit (GPU) configured to implement one or more trained neural network models.

In some embodiments, the mobile device 602 may integrate with internet of things (IoT) ecosystems and secure networks through its transceiver 610 to its functionality beyond personal authentication. For example, upon successful user authentication, the device may communicate with a smart home hub to unlock a door, with industrial control systems to grant access to restricted areas, or with financial systems to authorize transactions. Such connectivity may broaden the system's applicability to diverse environments that could benefit from secure and adaptive access control.

The processor-readable instructions 606 may include one or more instruction modules. The instruction modules may include computer program modules. In some embodiments, the functions of the instruction modules may be implemented in software, firmware, hardware (e.g., circuitry), or a combination of software and hardware, which are configured to perform particular operations or functions. The instruction modules may include one or more of a spatiotemporal data input module 620, an IMU data input module 622, a dynamic facial expression and device motion analysis module 624, a signature matching module 626, an access granting module 628, and an optional protective actions module 630, as well as other enabling and supporting software modules.

The spatiotemporal data input module 620 may include instructions to enable the processing system 604 to receive spatiotemporal data streams from the vision sensor 208 and prepare the data for processing. In some embodiments, the spatiotemporal data input module 620 may include instructions for receiving and temporarily buffering spatiotemporal data and providing the data for processing in the dynamic facial expression and device motion analysis module 624, such as providing the data as inputs to a trained neural network model. In some embodiments, the spatiotemporal data input module 620 may include instructions for preprocessing the spatiotemporal data, such as processing the spatiotemporal data by aligning and normalizing the data to remove noise and inconsistencies while maintaining temporal resolution prior to constructing the composite spatiotemporal trajectory. In some embodiments, the spatiotemporal data input module 620 may include instructions for focusing the processing of data from the vision sensor 208 on the user's face to facilitate capturing the spatiotemporal data of the user's facial features.

The IMU data input module 622 may include instructions to enable the processing system 604 to receive motion data streams from the IMU 210 and prepare the data for processing. In some embodiments, the IMU data input module 622 may include instructions for receiving and temporarily buffering and providing the IMU data for processing in the dynamic facial expression and device motion analysis module 624, such as providing the data as inputs to a trained neural network model in conjunction (e.g., synchronized) with spatiotemporal data. In some embodiments, the IMU data input module 622 may include instructions for labeling or applying metadata that includes timestamps or similar temporal information that may be used by the dynamic facial expression and device motion analysis module 624 and/or constructing a movement path of the mobile device 602 during a user authentication process.

The dynamic facial expression and device motion analysis module 624 may include instructions to enable the processing system 604 to process the input spatiotemporal image data of the user's face along with the mobile device movement data to output (e.g., generate or infer) the dynamic facial feature expression movements plus device movement elements of a user authentication gesture. In some embodiments, the dynamic facial expression and device motion analysis module 624 may include or be a neural network model, such as implemented in an NPU or GPU of the processing system, that is trained to perform the processing of various embodiments as described herein.

The signature matching module 626 may include instructions to enable the processing system 604 to authenticate the user by comparing the user authentication gesture recognized by the dynamic facial expression and device motion analysis module 624 to stored or trained authentication gestures of authorized users. In some embodiments, the signature matching module 626 may include or be a neural network model, such as implemented in an NPU or GPU of the processing system, that is trained to perform the signature matching operations of various embodiments as described herein.

In some embodiments, a single neural network model may be trained to perform the operations of both the dynamic facial expression and device motion analysis module and the signature matching module by receiving the spatiotemporal and IMU data as inputs and output an inference of whether the user performing the authentication process is an authorized user, such as within a predetermined degree of certainty. Thus, in some embodiments, these two modules 624, 626 may be a single instruction module.

The access granting module 628 may include instructions to enable the processing system 604 to activate, register with, or otherwise enable a user that is authenticated by the signature matching module 626 to use a secure operation or access a protected asset. In some implementations, the access granting module 628 may include instructions to enable the processing system 604 to permit the authenticated user to have full use of the mobile device 602. In some implementations, the access granting module 628 may include instructions to enable the processing system 604 to permit the authenticated user to access or use various other systems and/or devices such as, but not limited to, another computing system or device 632, secure networks 634, a wireless access point 636, a secure server 638, open a locked door 640 to a locked building or secure facility, open a safe 642, or access a secure database 644 or electronic file. In addition to granting access to protected assets, in some implementations the granting module 628 may enable the authorized user to view or perform a variety of secure operations, such as completing a financial transaction, executing a contract, submitting a confidential bid or proposal, and similar actions for which it is important to ensure the user is authorized to perform the transaction

The optional protective actions module 630 may include instructions to enable the processing system 604 to perform a variety of protective actions in response to the signature matching module 626 determining that the user is not an authenticated user because the performed authentication gesture (i.e., dynamic facial expression combined with device movement) did not match an authorized user's dynamic facial expression and device motion gesture. Some non-limiting examples of protective actions include: issuing a notification to the user (e.g., in a display and/or audible alert) that authentication failed; sending a notification to another computing device (e.g., a facility or network monitor) that authentication failed; initiating further authentication methods (e.g., requesting a fingerprint, voiceprint, or other biometric authentication method); initiating or prompting another system to initiate further security measures on the protected asset; and the like. In some embodiments, the optional protective actions module 630 may include instructions to enable the processing system 604 to recognize a spoofing attempt performed within the user authentication process and issue a special alert or alarm to an appropriate authority in response.

The processing system 604 may be configured to use the transceiver 610 to use wireless communication links 612, such as Wi-Fi and/or Bluetooth, to communicate with any of various protected assets 632-644, as well as another computing system or authority informed of a failed authentication process and/or spoofing attempt. In response to a failed authentication attempt or detected spoofing attempt, the system may notify connected IoT systems to trigger protective actions. For instance, the system may instruct a smart home hub to lock all doors or a factory control system to restrict access to sensitive areas. These capabilities make the system an integral part of a secure, interconnected IoT ecosystem.

The electronic storage 608 may include non-transitory storage media that electronically stores information. The electronic storage media of electronic storage 608 may include one or both system storage that is provided integrally (i.e., substantially non-removable) and/or removable storage that is removably connectable to the mobile device 602 (e.g., via a universal serial bus (USB) port, a firewire port, etc.). The electronic storage 608 may include one or more virtual storage resources (e.g., cloud storage, a virtual private network, and/or other virtual storage resources). Electronic storage 608 may store software algorithms, neural network model weights and activation parameters, information determined by the processing system 604, and/or other information that enables the processing system 604 to function as described herein.

The description of the functionality provided by the different instruction modules 620-630 is for illustrative purposes and is not intended to be limiting, as any of the modules 620-630 may provide more or less functionality than is described. For example, one or more of the modules 620-630 may be eliminated, and some or all of a module's functionality may be provided by other modules. As another example, the processing system 604 may be configured to execute one or more additional instruction modules that may perform some or all of the functionality of the modules 620-630.

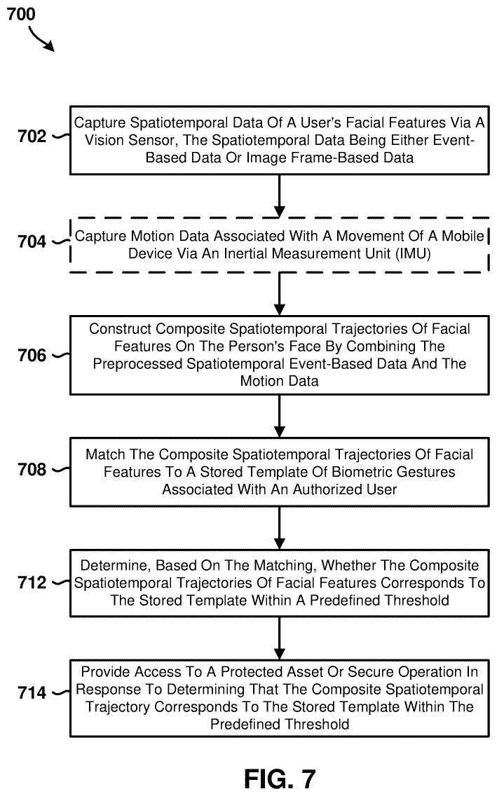

FIG. 7 is a process flow diagram illustrating an example method 700 for processing spatiotemporal data streams in a computing device (e.g., a smartphone or other mobile computing device) to accomplish a user authentication process in accordance with some embodiments. With reference to FIGS. 1A-7, the method 700 may be performed in a computing device (e.g., 104, 602) by a processing system (e.g., 604) encompassing one or more processors (e.g., processors 220-232, etc.), components, or subsystems discussed in this application. For ease of reference, the components of the computing device involved in performing method operations are referred to generally as a “processing system.”

In block 702, the processing system may perform operations including capturing spatiotemporal data of a user's facial features via a vision sensor in the mobile device, in which the spatiotemporal data is either event-based data or image frame-based data. In embodiments in which the spatiotemporal data is spatiotemporal event-based data, spatiotemporal event-based data associated with facial feature movements of the user may be captured via an event-based vision sensor configured to detect changes in illumination or contrast at individual sensor pixels and output asynchronous events corresponding to the detected changes. In such embodiments, the event-based vision sensor may output asynchronous events corresponding to changes in illumination or contrast with a temporal resolution of approximately one microsecond. Such facial feature movement data may be used by the processing system (e.g., in block 706) to recognize user-unique facial expression gesture patterns, as the variability in human faces, musculature, and expressions provides a biometric signature for individuals that is very difficult to emulate accurately.

In some embodiments, the operations of capturing the spatiotemporal data of the user's facial features via a vision sensor in block 702 may include capturing sparse spatiotemporal event-based data on particular facial features and facial expressions (e.g., facial expression gestures) that can be matched to previous dynamical trajectories of facial features related to facial expression gestures, mobile device movements, or both combined without capturing images of the user's face. For example, by limiting the processing of event-based data on a user's eyes, lips, eyebrows, and/or some facial muscles in the cheeks or forehead, the spatiotemporal data on the user's facial expressions may provide sufficient information to enable recognizing a user-specific facial feature expression gesture or signature without recording an image of the user's face. This capability to perform dynamic facial feature recognition without recording images of the user may be useful in applications where user privacy is important or a legal requirement. This may enable applications that use facial recognition to provide a high degree of protection against spoofing without violating privacy laws or user preferences.

In some embodiments, the operations of capturing the spatiotemporal data of the user's facial features via a vision sensor in block 702 may include capturing spatiotemporal data of facial features that includes data corresponding to micro-expressions of the user. The use of an event-based vision sensor, a high frame-rate camera, or a sensor that combines both event-based sensing and high-frame-rate imaging to capture facial features may enable the processing system to recognize or process dynamic expressions on a time scale that enables analysis of micro-expressions that last for only a few milliseconds. Such micro-expressions can be revealing about a person's state of mind, and thus may be used by the processing system to recognize individuals under duress, such as being forced to perform the facial biometric authentication process, or perform the process with nefarious intent. Such capabilities may be useful for securing protected assets and protecting users.

In block 704, the processing system may perform operations including capturing motion data associated with a movement of the mobile device via an IMU. In some embodiments, capturing the motion data associated with the movement of the mobile device via the IMU may include capturing motion data that can be used to identify a lateral motion of the mobile device (e.g., illustrated in FIGS. 1A and 1B), and, any planar motion (motion in a plane facing the user), and motion bringing the mobile device closer or further away from the user's face which may be used by the processing system to detect information about a depth and three-dimensional features of the user's face by imaging the user from varying angles or perspectives. The motion data may include labeling or associating timestamps or similar temporal information with IMU data elements to enable the processing system to recognize path, velocity, and acceleration features of the mobile device's motion during the gesture capture process. Such data may be used by the processing system (e.g., in block 706) to recognize user-unique patterns in arm movements, as the variability in human arm sizes, musculature, and learned movements may provide a biometric signature for individuals that is very difficult to emulate by others or machines. Such labeling or timestamping of the IMU data stream may also be used by the processing system (e.g., in block 706) to correlate facial feature trajectories with mobile device positions and motions to provide a further element of a biometric signature.

Block 704 is shown as optional because in some embodiments user authentication may be based solely on dynamic facial feature expressions as explained with reference to FIG. 3B.

In block 706, the processing system may perform operations including constructing composite spatiotemporal trajectories of facial features on the person's face by combining the spatiotemporal event-based or image frame-based data and the motion data. As described, these operations may include extracting and organizing feature details in brief time intervals during the gesture process to produce a biometric signature of the user. In some embodiments, a trained neural network may perform this processing by receiving the spatiotemporal event-based data or image frame-based and the motion data as inputs and outputting an inference in a form suitable for matching to biometric signatures of authorized users in block 708. Such a neural network may be trained on spatiotemporal trajectories of dynamic facial expression gestures and device movements.

In some embodiments, the operations in block 706 may include processing the spatiotemporal data by aligning and normalizing the data to remove noise and inconsistencies while maintaining temporal resolution prior to constructing the composite spatiotemporal trajectory.

As used herein, the term “aligning” spatiotemporal data may refer to the process of synchronizing and correlating data streams from different sources, such as a vision sensor and an inertial measurement unit, based on their temporal attributes. In some implementations, aligning may involve matching timestamps or temporal markers associated with spatiotemporal event-based data or image frame-based data with corresponding motion data to ensure that facial feature movements and device movements are properly correlated in time. This alignment may enable the construction of composite spatiotemporal trajectories that accurately represent the dynamic interplay between facial expressions and device motion during an authentication session.

As used herein, the term “normalizing” spatiotemporal data may refer to the process of adjusting and standardizing data values to remove noise and inconsistencies while preserving temporal resolution. Normalizing may involve scaling data to a common range, removing outliers or artifacts, compensating for variations in sensor output, and adjusting for environmental factors such as lighting conditions or device orientation. Normalizing spatiotemporal data may improve data quality for subsequent analysis by ensuring that data from different capture sessions or under varying conditions can be consistently compared and processed.

In some embodiments, the processing in block 706 may be limited to the processing of dynamic facial features only as described with reference to FIG. 3B.

In block 708, the processing system may perform operations including matching the composite spatiotemporal trajectories of facial features to a stored template of biometric gestures associated with an authorized user, and in block 710 determine, based on the matching, whether the composite spatiotemporal trajectories of facial features correspond to the stored template within a predefined threshold. In some embodiments, this match operation may involve determining whether the user's dynamic facial feature expressions and device motion match an authorized user's saved or trained biometric signature within a threshold level of similarity to account for the natural variation in facial expressions and arm movements. In some embodiments, the operations in blocks 708 and 710 may be limited to matching dynamic facial feature gestures to a stored template of biometric gestures associated with an authorized user as described with reference to FIG. 3B.

In some embodiments, the match operation in block 710 may be performed by a neural network model that has been trained to recognize the dynamic facial feature and device motion biometric signature of authorized users through a sufficient number of training sessions to encompass the natural variation in facial expressions and arm movements. In some embodiments, the system may implement PLEIADES or Binned PLEIADES processing as described herein with reference to FIGS. 4 and 5 to analyze motion patterns for authentication using IMU data. This may improve recognition accuracy and reduce reliance on vision sensors.

In block 712, the processing system may perform operations including providing access to a protected asset or secure operation in response to determining that the composite spatiotemporal trajectories correspond to the stored template within the predefined threshold. Non-limiting examples of protected assets or secure operations to which an authenticated user may be granted access may include unlocking the mobile device, authorizing a transaction, authorizing use of a vehicle, and/or granting access to a restricted resource or file. Other assets and operations to which the authenticated user may be granted access are described herein.

During training sessions, users may perform predefined facial gestures and device motions tailored to specific applications. For example, high-security scenarios like banking may involve precise facial expressions and device movements, while casual device access might use simpler gestures. This flexibility may allow the system to adapt to the user's needs and adjust the security level for different contexts.

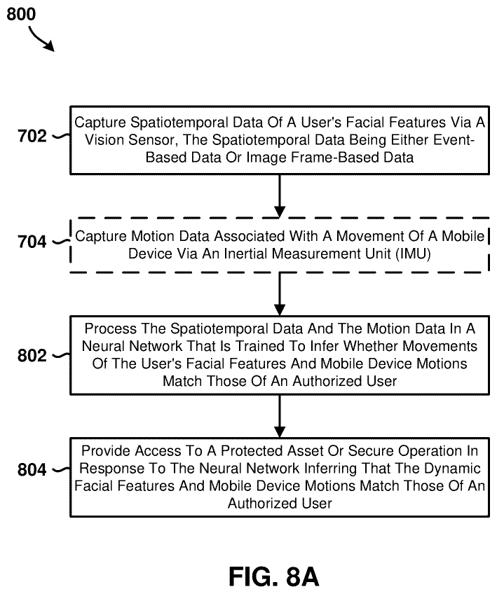

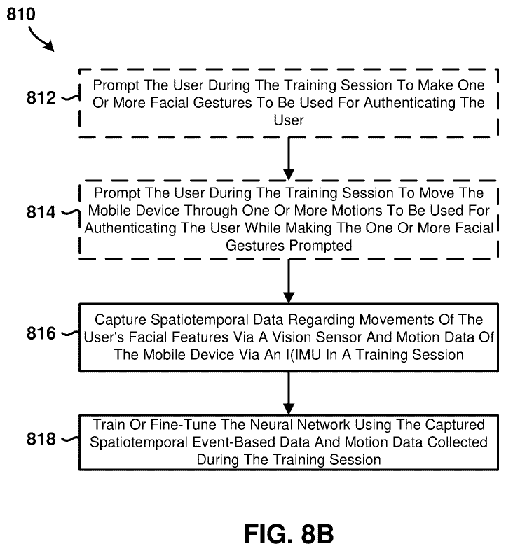

FIG. 8A is a process flow diagram illustrating an example method 800 for processing spatiotemporal data streams using a trained neural network model executing in a computing device (e.g., a smartphone or other mobile computing device) to accomplish a user authentication process in accordance with some embodiments. With reference to FIGS. 1A-8A, the method 800 may be performed in a computing device (e.g., 104, 602) by a processing system (e.g., 604) encompassing one or more processors (e.g., processors 220-232), components, or subsystems discussed in this application. In some embodiments, the vision sensor (e.g., 208), the IMU (e.g., 210), and an NPU or GPU implementing the neural network may be combined in a single integrated circuit assembly. For ease of reference, the components of the computing device involved in performing method of operations are referred to generally as a “processing system.”

In block 702, the processing system may perform operations including capturing spatiotemporal data regarding movements of a user's facial features via a vision sensor in the mobile device, wherein the spatiotemporal data is either event-based data or image frame-based data. In embodiments in which the spatiotemporal data is spatiotemporal event-based data, spatiotemporal event-based data associated with facial feature movements of the user may be captured via an event-based vision sensor configured to detect changes in illumination or contrast at individual sensor pixels and output asynchronous events corresponding to the detected changes. The operations performed in block 702 may be the same as or similar to the operations in the same numbered block of the method 700 described above.

In block 704, the processing system may perform operations including capturing motion data associated with movements of the mobile device via an IMU. The operations performed in block 704 may be the same as or similar to the operations in the same numbered block of the method 700 described above. Again, block 704 is shown as optional because in some embodiments user authentication may be based solely on dynamic facial feature expressions as explained with reference to FIG. 3B.

In block 802, the processing system may perform operations including processing the spatiotemporal data and the motion data in a neural network that is trained to infer whether movements of the user's facial features and mobile device motions match those of an authorized user. In some embodiments, the neural network may use PLEIADES processing of the spatiotemporal data and motion data to reduce latency and efficiently process high-frequency data to support dynamic facial expression gesture analyses and inference. In some embodiments, the spatiotemporal data is frame-based data, and the neural network may use Binned PLEIADES processing of the spatiotemporal event-based data or frame-based vision data and motion data that looks at multiple frames in the past to perform dynamic facial expression gesture analyses and inference. In some embodiments, the processing in block 802 may be limited to the processing of dynamic facial features by the neural network as described with reference to FIG. 3B.

In block 804, the processing system may perform operations including providing access to a protected asset or secure operation in response to the neural network inferring that the dynamic facial features and mobile device motions match those of an authorized user. The operations performed by the processing system in block 804 may include or be similar to the operations performed by the processing system in block 712 of the method 700 described above.

FIG. 8B is a process flow diagram illustrating an example method 810 for training a neural network model executing in a computing device (e.g., a smartphone or other mobile computing device) to accomplish a user authentication process in accordance with some embodiments. With reference to FIGS. 1A-8B, the method 810 may be performed in a computing device (e.g., 104, 602) by a processing system (e.g., 604) encompassing one or more processors (e.g., processors 220-232, etc.), components, or subsystems discussed in this application. For ease of reference, the components of the computing device involved in performing method operations are referred to generally as a “processing system.”

In optional block 812, the processing system may perform operations including prompting the user during the training session to make one or more facial expression gestures to be used for authenticating the user. This prompting may be presented on a user interface configured to lead the user through the training process.

In optional block 814, the processing system may perform operations including prompting the user during the training session to move the mobile device through one or more motions to be used for authenticating the user while making the one or more facial expression gestures prompted in block 812. This prompting may also be on a user interface configured to lead the user through the training process

In block 816, the processing system may perform operations including capturing spatiotemporal data regarding movements of the user's facial features via a vision sensor and motion data of the mobile device via an IMU in a training session in which the spatiotemporal data is either event-based data or image frame-based data. The capturing of such user's facial feature expressions during the training session may be the same as or similar to the operations in blocks 702 and 704 of the methods 700 and 800 as described above.

In block 818, the processing system may perform operations including training or fine-tuning the neural network using the captured spatiotemporal data and motion data collected during the training session. This model training may use any known machine learning and neural network training method, including using the fact that the user performing the training sessions is an authorized user as the truth set for such training.

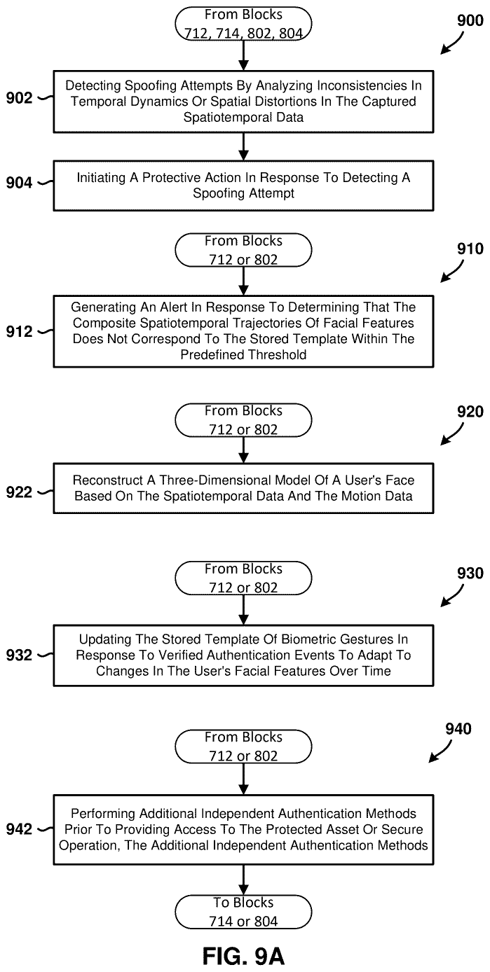

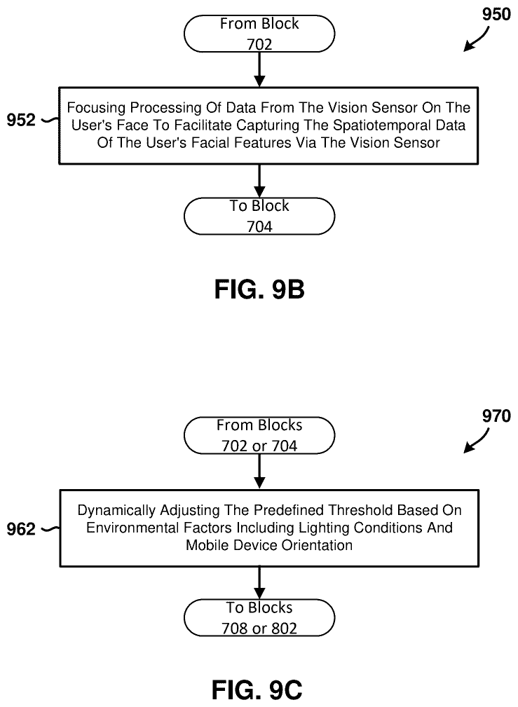

FIGS. 9A-9C illustrates further operations to enhance or leverage the security capabilities of either of methods 700 (FIG. 7) or 800 (FIG. 8A) as illustrated.

FIG. 9A illustrates alternative operations methods 900, 910, 920, 930, and 940 of operations that may be performed as part of either of methods 700 (FIG. 7) or 800 (FIG. 8A) of additional actions that the mobile device processing system may perform based on the processing of spatiotemporal data in either method.

Referring to method 900, in block 902, the processing system may perform operations including detecting spoofing attempts by analyzing inconsistencies in temporal dynamics or spatial distortions in the captured spatiotemporal data. For example, the results of processing the spatiotemporal image and IMU data may be used to recognize static features that should be dynamic or hesitant or unusually smooth motion of the mobile device inconsistent with a human-made motion. For example, in addition to not matching an authorized user's stored or trained dynamic biometric signature, the comparison algorithm or trained neural network model may recognize feature and device movements that are expected in various spoofing techniques. Such processing or pattern recognition may defeat sophisticated efforts to spoof security measures using manikins to reproduce facial dimensions and/or robotic manipulators to reproduce movements of the mobile device.

To counter spoofing attempts, the system may analyze temporal inconsistencies and spatial distortions in the captured spatiotemporal data. For example, advanced 3D-printed masks or robotic manipulators may exhibit subtle irregularities in motion patterns or depth perception, which the system may detect. By using the microsecond precision of EBVS, high frame rate vision sensors, or sensors that combines both event-based sensing and high-frame-rate imaging and the motion data from the IMU, the system may identify and neutralize sophisticated spoofing techniques.

In block 904, the processing system may perform operations including initiating a protective action in response to detecting a spoofing attempt. Since spoofing the dynamic facial feature and device motion authentication methods would require difficult to implement reproductions of an authorized user, detection of a spoofing attempt may indicate a particularly significant or dangerous meriting enhanced security measures for the protected asset or secure operation.

Referring to method 910, in block 912, the processing system may perform operations including generating an alert in response to determining that the composite spatiotemporal trajectories of facial features do not correspond to the stored template within the predefined threshold. In some embodiments, this alert may be or include an indication emitted and/or displayed on the mobile device that performance of the secure operation or access to the protected asset is denied. In some embodiments, this alert may be or include a message sent to another computing device, such as a security center server or display that someone attempted to be authorized but failed the dynamic facial feature and device movement authentication method. Other types of alerts may be issued or transmitted in block 912.

Referring to method 920, in block 922, the processing system may perform operations including reconstructing a three-dimensional model of a user's face based on the spatiotemporal data and the motion data. Such a reconstruction may be useful for recording the user attempting to execute the dynamic facial feature and device motion authentication, particularly in embodiments that use event-based image sensors that may not otherwise capture an image of the user.

Referring to method 930, in block 932, the processing system may perform operations including updating the stored template of biometric gestures in response to verified authentication events to adapt to changes in the user's facial features over time. In some embodiments, this may involve adjusting dynamic feature details stored in memory (e.g., in a template) to account for changes or variability in the user's facial features, expressions, and/or arm movements over time. In some embodiments, this may involve machine learning, fine-tuning, or augmented training of the neural network to learn changes or variability in the user's facial features, expressions, and/or arm movements over time.

Referring to method 940, in block 942, the processing system may perform operations including performing one or more additional independent authentication checks according to one or more methods prior to providing access to the protected asset or secure operation, the additional independent authentication checks can be using methods including one or more of fingerprint verification, palmprint verification, voiceprint verification, facial recognition, password verification, or two-factor authentication.

After performing the additional authentication methods in block 942, the processing system may perform the operations to authorize the user to perform a secure operation or access a protected asset as described.

FIG. 9B illustrates further operations 950 that may be performed as part of either of methods 700 (FIG. 7) or 800 (FIG. 8A) for capturing facial feature data. Specifically, as part of or following the operations in block 702, the processing system may perform operations including focusing processing of data from the vision sensor on the user's face to facilitate capturing the spatiotemporal data of the user's facial features via the vision sensor in block 952. Such operations may use facial recognition processing to localize the user's face within the image frames and exclude from further processing image details that surround the face. This may enable the user to perform the dynamic facial feature authentication process in a crowded environment or against a moving or dynamic background (e.g., window of a moving vehicle). After focusing on the user's face, the processing system may perform the operations in block 704 as described.

FIG. 9C illustrates further operations 960 that may be performed as part of either of methods 700 (FIG. 7) or 800 (FIG. 8A) for taking into account environmental factors in adjusting the sensitivity, parameters, or thresholds applied in determining whether the user's dynamic facial feature expressions and device movements matches a saved or trained dynamic facial biometric signature of an authorized user in either blocks 708 or 802. Specifically, after capturing vision data in 702 or IMU data in block 704, the processing system may perform operations including dynamically adjusting the predefined threshold based on environmental factors including lighting conditions and mobile device orientation in block 962. Such operations may consider environmental conditions such as lighting conditions and mobile device orientation, as well as other factors, such as temperature, precipitation, and external motion (e.g. when the user is in a moving vehicle) that may affect the vision sensor and/or IMU data. After adjusting the thresholds, the processing system may perform the operations in block 706 or 802 as described.

Some embodiments may include a system for secure biometric authentication that includes a sensor configured to capture spatiotemporal data associated with movements of a user's facial features (in which the spatiotemporal data is either event-based data or image frame-based data), an IMU configured to capture motion data associated with a movement of the computing device, a memory, and a processor coupled to the sensor, the IMU, and the memory. In some embodiments, the processor may be configured to process the spatiotemporal data and the motion data using a neural network that is trained to infer whether movements of the user's facial features and computing device motions match those of an authorized user, and provide access to a protected asset or secure operation in response to the neural network inferring that the dynamic facial features and computing device motions match those of an authorized user. In some embodiments, the spatiotemporal data may be event-based data, and the sensor may be an event-based vision sensor configured to detect changes in illumination or contrast at individual sensor pixels and output asynchronous events corresponding to the detected changes. In some embodiments, the neural network uses PLEIADES processing of the spatiotemporal data and motion data to reduce latency and efficiently process high-frequency data to support dynamic facial expression gesture analyses and inference. In some embodiments, the spatiotemporal data may be frame-based data, and the neural network may use Binned PLEIADES processing of the spatiotemporal data and motion data that looks at multiple frames in the past to perform dynamic facial expression gesture analyses and inference. In some embodiments, the sensor, the IMU, and a neural processing unit (NPU) implementing the neural network may be combined in a single integrated circuit assembly.

Some embodiments may include methods for authenticating a user with a computing device. In some embodiments, the methods may include capturing, via a vision sensor of the computing device, spatiotemporal data associated with facial features of a user, the spatiotemporal data including event-based data or image frame-based data, capturing, via an inertial measurement unit of the computing device, motion data associated with movement of the computing device, combining the spatiotemporal data and the motion data into a single data structure to generate a composite spatiotemporal trajectory, the composite spatiotemporal trajectory representing interplay between the facial features of the user and the movement of the computing device, comparing the composite spatiotemporal trajectory with a stored template designated as a biometric gesture associated with an authorized user, determining, based on the comparing, whether the composite spatiotemporal trajectory and the stored template match beyond a predefined threshold value of a similarity measure, and providing, in response to determining that the composite spatiotemporal trajectory and the stored template match beyond the predefined threshold value of the similarity measure, an access control signal for enabling access to a protected asset or enabling a secure operation.

Some embodiments may further include capturing the spatiotemporal data as spatiotemporal event-based data by receiving, from an event-based vision sensor of the computing device, a plurality of asynchronous events each including an event timestamp, a pixel location, and an event polarity. Some embodiments may further include capturing the plurality of asynchronous events with a temporal resolution of approximately one microsecond. Some embodiments may further include capturing the spatiotemporal data as the image frame-based data by capturing, via the vision sensor, a plurality of image frames each including a frame timestamp. Some embodiments may further include capturing the plurality of image frames at a frame rate of at least 120 frames per second. Some embodiments may further include focusing processing of data from the vision sensor on a face region corresponding to a face of the user by identifying the face region in the spatiotemporal data and discarding spatiotemporal data outside the face region.

Some embodiments may further include aligning the spatiotemporal data with the motion data by synchronizing a plurality of timestamps of the spatiotemporal data with a plurality of timestamps of the motion data. Some embodiments may further include normalizing the spatiotemporal data by reducing sensor noise in the spatiotemporal data and scaling values of the spatiotemporal data to a common range, and normalizing the motion data by removing sensor bias from the motion data and filtering noise in the motion data. Some embodiments may further include capturing the motion data as motion data representing a lateral motion of the computing device during capturing of the spatiotemporal data for estimating depth associated with the facial features of the user. Some embodiments may further include estimating a device pose time series from the motion data, and incorporating the device pose time series into the composite spatiotemporal trajectory. Some embodiments may further include augmenting the composite spatiotemporal trajectory with a synchrony feature derived from a temporal correlation between a facial-feature motion signal computed from the spatiotemporal data and a device-motion signal computed from the motion data. Some embodiments may further include generating the similarity measure by executing, on the computing device, a neural network configured to receive the composite spatiotemporal trajectory and to output a match score based on the composite spatiotemporal trajectory and the stored template.

Some embodiments may further include receiving the spatiotemporal data as spatiotemporal event-based data including a plurality of asynchronous events, updating, in the neural network, a plurality of neuron states in response to the plurality of asynchronous events, and applying, in the neural network, spatiotemporal kernels offset in at least one of a spatial dimension and a temporal dimension in response to event timestamps and event polarities. Some embodiments may further include binning the spatiotemporal data into a plurality of time bins, updating, in the neural network, an internal state vector across the plurality of time bins, and generating, from the internal state vector, a temporal convolution output using a polynomial expansion of temporal kernel coefficients. Some embodiments may further include capturing the spatiotemporal event-based data as sparse spatiotemporal event-based data by limiting the plurality of asynchronous events to a plurality of facial-feature regions of interest corresponding to at least one of an eye region and a mouth region.

Some embodiments may further include discarding, after generating the composite spatiotemporal trajectory, at least a portion of the spatiotemporal data in raw sensor form. Some embodiments may further include extracting, from the spatiotemporal data, a micro-expression feature representing facial-feature motion occurring within a time interval shorter than 100 milliseconds (or shorter than 10 milliseconds, 1 millisecond, etc.). Some embodiments may further include computing a duress indicator based on the micro-expression feature, and withholding the access control signal in response to determining that the duress indicator exceeds a duress threshold value. Some embodiments may further include detecting an inconsistency in temporal dynamics or spatial distortion in at least one of the spatiotemporal data, the motion data, and the composite spatiotemporal trajectory, and detecting a spoofing attempt based on the inconsistency.

Some embodiments may further include initiating a protective action in response to detecting the spoofing attempt. Some embodiments may further include generating an alert in response to determining that the composite spatiotemporal trajectory and the stored template do not match beyond the predefined threshold value of the similarity measure. Some embodiments may further include reconstructing a three-dimensional model of a face of the user based on the spatiotemporal data and the motion data. Some embodiments may further include comparing the three-dimensional model with a stored three-dimensional template associated with the authorized user, and modifying the determining based on the comparing the three-dimensional model with the stored three-dimensional template. Some embodiments may further include measuring a lighting condition during capturing the spatiotemporal data, and dynamically adjusting the predefined threshold value of the similarity measure based on the lighting condition.

Some embodiments may further include measuring a mobile device orientation during capturing the spatiotemporal data, and dynamically adjusting the predefined threshold value of the similarity measure based on the mobile device orientation. Some embodiments may further include detecting a verified authentication event in response to providing the access control signal, and updating the stored template using the composite spatiotemporal trajectory associated with the verified authentication event. Some embodiments may further include capturing fingerprint data via a fingerprint sensor of the computing device, comparing the fingerprint data with a stored fingerprint template associated with the authorized user, and withholding the access control signal in response to determining that the fingerprint data and the stored fingerprint template do not match.

Some embodiments may further include capturing voice data via a microphone of the computing device, extracting a voiceprint from the voice data, comparing the voiceprint with a stored voiceprint template associated with the authorized user, and withholding the access control signal in response to determining that the voiceprint and the stored voiceprint template do not match. Some embodiments may further include receiving a passcode via a user interface of the computing device, comparing the passcode with a stored passcode value associated with the authorized user, and withholding the access control signal in response to determining that the passcode and the stored passcode value do not match. Some embodiments may further include capturing the spatiotemporal data and the motion data using an integrated sensor module including the vision sensor and the inertial measurement unit. Some embodiments may further include executing the neural network by operating a neural processing unit of the computing device. Some embodiments may further include unlocking the computing device in response to providing the access control signal. Some embodiments may further include authorizing a transaction in response to providing the access control signal. Some embodiments may further include authorizing operation of a vehicle in response to providing the access control signal. Some embodiments may further include illuminating the face of the user with infrared light during capturing the spatiotemporal data.

Some embodiments may include methods of training the neural network, which may include capturing spatiotemporal data associated with movements of the user's facial features via a sensor and motion data of the mobile device via an IMU in a training session (in which the spatiotemporal data is either event-based data or image frame-based data), training or fine-tuning the neural network using the captured spatiotemporal data and motion data. Some embodiments may include prompting the user during the training session to make one or more facial expression gestures to be used for authenticating the user. Some embodiments may include prompting the user during the training session to move the mobile device through one or more motions to be used for authenticating the user while making one or more facial expression gestures.

Some embodiments may include methods of authenticating a user with a computing device using synchronized facial sensing and motion sensing. In some embodiments, the methods may include capturing, via a vision sensor of the computing device, spatiotemporal data associated with facial features of a user, capturing, via an inertial measurement unit of the computing device, motion data associated with movement of the computing device, synchronizing the spatiotemporal data and the motion data using timestamps, processing the spatiotemporal data and the motion data in a neural network executing on the computing device, generating, from an output of the neural network, an authorization score indicating whether the spatiotemporal data and the motion data match an authorized user, determining that the authorization score satisfies an acceptance threshold value, and providing, in response to determining that the authorization score satisfies the acceptance threshold value, an access control signal for enabling access to a protected asset or enabling a secure operation. Some embodiments may further include capturing the spatiotemporal data as spatiotemporal event-based data by receiving, from an event-based vision sensor of the computing device, a plurality of asynchronous events each including an event timestamp, a pixel location, and an event polarity. Some embodiments may further include binning the spatiotemporal data into a plurality of time bins, and processing the plurality of time bins in the neural network using an internal state vector updated across the plurality of time bins. Some embodiments may further include generating, from the output of the neural network, a biometric embedding for the user, comparing the biometric embedding with a stored biometric embedding associated with the authorized user, and generating the authorization score based on the comparing the biometric embedding with the stored biometric embedding.

Some embodiments may include methods of training a neural network on a computing device for authenticating a user based on dynamic facial expressions and device motion. In some embodiments, the methods may include prompting, via a user interface of the computing device, the user to perform an enrollment gesture, capturing, via a vision sensor of the computing device during performance of the enrollment gesture, spatiotemporal enrollment data associated with facial features of the user, capturing, via an inertial measurement unit of the computing device during performance of the enrollment gesture, motion enrollment data associated with movement of the computing device, synchronizing the spatiotemporal enrollment data and the motion enrollment data using timestamps, training, on the computing device, the neural network using the synchronized spatiotemporal enrollment data and motion enrollment data, and storing, in a memory of the computing device, trained model parameters for the neural network associated with the user. Some embodiments may further include prompting, via the user interface of the computing device, the user to perform the enrollment gesture as a user-selected sequence of facial expressions. Some embodiments may further include prompting, via the user interface of the computing device, the user to perform the enrollment gesture as a coordinated sequence of the facial expressions and a device motion pattern. Some embodiments may further include generating a stored template designated as a biometric gesture associated with the user by transforming the synchronized spatiotemporal enrollment data and motion enrollment data into a composite spatiotemporal trajectory, and storing the stored template in the memory of the computing device.

Some embodiments may include methods for authenticating a user with a computing device based on dynamic facial expressions. In some embodiments, the methods may include capturing, via a vision sensor of the computing device, spatiotemporal data associated with facial features of a user, constructing a spatiotemporal trajectory from the spatiotemporal data, comparing the spatiotemporal trajectory with a stored template designated as a biometric gesture associated with an authorized user, determining, based on the comparing, whether the spatiotemporal trajectory and the stored template match beyond a predefined threshold value of a similarity measure, and providing, in response to determining that the spatiotemporal trajectory and the stored template match beyond the predefined threshold value of the similarity measure, an access control signal for enabling access to a protected asset or enabling a secure operation. Some embodiments may further include capturing the spatiotemporal data as sparse spatiotemporal event-based data by receiving, from an event-based vision sensor of the computing device, a plurality of asynchronous events limited to a plurality of facial-feature regions of interest.

Some embodiments may include methods for authenticating a user with a computing device based on device motion. In some embodiments, the methods may include capturing, via an inertial measurement unit of the computing device, motion data associated with movement of the computing device during an authentication attempt, constructing a motion trajectory from the motion data, comparing the motion trajectory with a stored motion template designated as a biometric gesture associated with an authorized user, determining, based on the comparing, whether the motion trajectory and the stored motion template match beyond a predefined threshold value of a similarity measure, and providing, in response to determining that the motion trajectory and the stored motion template match beyond the predefined threshold value of the similarity measure, an access control signal for enabling access to a protected asset or enabling a secure operation. Some embodiments may further include processing the motion data in a neural network executing on the computing device, and generating the similarity measure using an output of the neural network.

As discussed, various embodiments include methods, and computing devices (e.g., mobile devices, etc.) configured to implement the methods, of combining dynamic facial expression recognition with synchronized mobile device motion detection to securely authenticate a user. Unlike conventional facial recognition systems that rely on static images, the embodiments may use the unique characteristics of a user's facial movements and coordinated device motion to generate a biometric signature. This signature incorporates dynamic, user-specific elements that cannot be easily duplicated and thus is inherently more resistant to unauthorized replication than conventional solutions. During the authentication process, users may perform specific facial gestures or movements of facial features while the device simultaneously records associated motion data to generate a robust multi-factor authentication pattern. In some embodiments, the computing device may include advanced vision sensors, such as high-frame-rate cameras or event-based vision sensors (EBVS), designed to capture rapid facial movements with microsecond-level temporal resolution. These sensors may allow precise tracking of subtle and transient facial expressions that contribute to the user's biometric signature. In addition, some embodiments may implement “motor signature” authentication by combining facial expression data with arm motion patterns detected through an IMU integrated into the device. This dual-layer system may enhance security by using dynamic facial gestures and device motion together to create a highly individualized and secure authentication signature. For added versatility, some embodiments may integrate other authentication methods, such as fingerprint recognition or voice authentication, to further strengthen the system's reliability.

Some embodiments improve user authentication methods for granting users permission to perform secure operations or access protected resources. For example, authenticated users may be permitted to activate or use the mobile device, access other computing systems, access protected data files, and/or access secure networks, as well as authorize any of a variety of financial or contractual transactions, grant access to restricted resources, and/or control vehicle operations. By combining the benefits of dynamic motion analysis and facial expression recognition with advanced processing capabilities to deliver a secure, efficient, and adaptable biometric authentication system, various embodiments provide nearly spoof-proof security suitable for high-risk or high-value asset protections.

Some embodiments improve the efficiency and accuracy of user authentication systems by combining EBVS technology with motion data from IMUs. By leveraging asynchronous event streams from the EBVS, the embodiments allow high-frequency processing of dynamic facial expressions and device motion trajectories to reduce latency and enhance the system's ability to recognize unique biometric patterns, even under varying environmental conditions such as low lighting or device movement.

Some embodiments preprocess spatiotemporal data streams to remove noise while preserving temporal resolution. This preprocessing may significantly enhance data quality for subsequent analysis by a trained neural network. The neural network may operate in real-time to infer patterns in dynamic facial expressions and device motion, creating a composite biometric signature. This signature may be matched against stored templates using advanced algorithms to ensure reliable authentication. The technical integration of these components may allow for secure and adaptable authentication across diverse applications.

Some embodiments may address challenges in traditional facial recognition systems, such as susceptibility to spoofing, by introducing a dual-layer authentication method that combines dynamic facial feature recognition with correlated device motion analysis. Some embodiments may include a system architecture that allows the EBVS and IMU work cohesively to construct spatiotemporal trajectories that are unique to each user. This enhances security and reduces the computational burden typically associated with processing dense image data by focusing on sparse, event-based inputs.

Some embodiments may be implemented via an SOC architecture that includes an integrated vision sensor, IMU, and NPU. This configuration may allow for real-time processing of high-frequency data streams with minimal power consumption. This modular design may support adaptability for various hardware platforms to allow for deployment across mobile devices, IoT systems, and industrial applications. Such technical improvements highlight the system's ability to solve practical problems in secure authentication while maintaining robust performance under diverse operational conditions.

Some embodiments may use advanced neural network models trained to process dynamic spatiotemporal data streams. These models may be configured for high-dimensional pattern recognition, allowing the system to distinguish subtle variations in user behavior. For example, micro-expressions and nuanced device motion patterns may be captured and analyzed to ensure accurate user identification. These technical advancements may enhance the system's robustness and applicability to heightened security scenarios, such as financial transactions and access to sensitive infrastructure.

The embodiments allow a user to unlock a device by performing a short facial gesture while moving the mobile device through a personal motion pattern. The mobile device checks the combined pattern (rather than a static face snapshot). A camera and a motion sensor capture the live sequence and compare it to a stored gesture template for that user to support fast on-device decisions and reduce reliance on remote services (which, in turn, supports privacy and operational resilience).

Conventional facial authentication focuses on static geometry plus generic liveness checks. The embodiments define a biometric gesture as a time-ordered interplay between facial-feature motion and mobile-device motion, represented as a composite spatiotemporal trajectory. In some embodiments, an event-based vision sensor may provide microsecond-timestamped changes, and an inertial measurement unit may provide synchronized motion data, enabling the stored template to reflect both facial and handling dynamics. Unlike static face matching and motion biometrics (which treat mobile device motion as a disturbance), the embodiments use mobile device motion as a biometric signal. Further, gesture-template matching on the composite spatiotemporal trajectory adds a distinct authentication factor grounded in correlated dynamics across two sensors.

Sparse spatiotemporal event data and motion data reduce data volume relative to dense video frames, which reduces memory traffic and interconnect bandwidth during user authentication. Lower memory traffic and lower interconnect bandwidth support shorter user authentication latency and lower energy draw on the SOC, which may in turn allow the device to provide longer battery life and fewer thermal throttling events. The composite spatiotemporal trajectory also tolerates hand motion and low light, so the system spends less time on retries and fallback flows such as passcodes. On-device inference keeps biometric processing local, which may reduce network transactions and exposure of facial imagery. These effects improve device unlock, transaction approval, and access control across a network of protected assets.

In some embodiments, the processing system may be configured to address an objective technical problem of high latency and high memory traffic during user authentication under mobile device motion. The processing system may receive spatiotemporal data from a vision sensor and motion data from an inertial measurement unit, and the spatiotemporal data may have an event-based format. The processing system may construct a composite spatiotemporal trajectory from spatiotemporal data and motion data. The processing system may apply a neural network with PLEIADES processing to the composite spatiotemporal trajectory. The composite spatiotemporal trajectory and the neural network may reduce end-to-end user authentication latency from, for example, 120 ms to 35-60 ms, as indicated by timestamp logs at the sensor ingress and in the user authentication decision. The event-based format of spatiotemporal data may, for example, reduce DRAM read and write volume by 30-75 percent and/or sensor-bus bandwidth by 10-40 MB/s (as measured by hardware performance counters and interconnect traffic logs). Lower DRAM read and write volume may reduce energy by, for example, 5-20 percent, per power-rail measurements (e.g., during a 1,000-attempt test set, etc.).

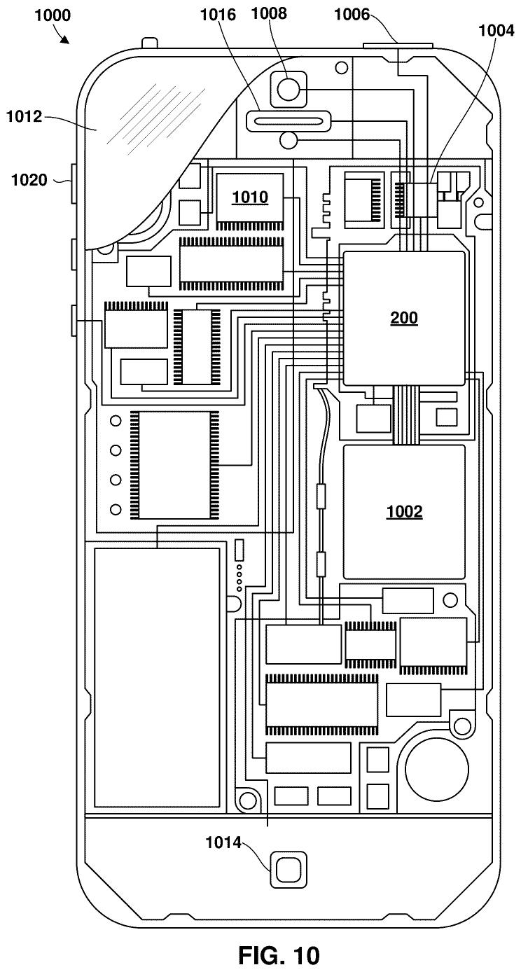

FIG. 10 is a component block diagram of a mobile device 1000 suitable for use with various embodiments. With reference to FIGS. 1A-10, various embodiments may be implemented on a variety of mobile devices. A mobile device 1000 may include a processing system 200, such as in the form of an SOC illustrated in FIG. 2, coupled to internal memory 1002, and a wireless transceiver 1004 that is coupled to an antenna 1006. In various embodiments, the mobile device 1000 may further include a high-frame-rate camera or event-based vision sensor 1008 and an IMU 1010, both coupled to the processing system 200 and configured to perform operations described herein. The processing system 200 may be further coupled to a user interface display 1012 (e.g., a touch-sensitive display), a microphone 1014, and a speaker 1016. In some embodiments, the high-frame-rate camera or event-based vision sensor 1008 may be positioned on the same side of the mobile device 1000 as the display 1012, as illustrated in FIG. 10, to enable a user to monitor the user's facial expressions on the display while performing a dynamic facial expression authentication action as described herein. The mobile device 1000 may further include various buttons, which may include a fingerprint sensor 1020 that may be used in some embodiments to provide a further biometric signal of a user.

The following paragraphs provide example implementations of various embodiments in the form of methods, which may also be performed in a computing device having a memory; a high-frame-rate vision sensor or an event-based vision sensor; an IMU; a neural network processor; and a processor coupled to the memory, the vision sensor, the IMU, and the neural network processor, and configured to perform operations of any of following example methods.

Example 1. A method for secure biometric authentication using dynamic facial expression gestures and motion, the method including: capturing spatiotemporal data of a user's facial features via a vision sensor in a mobile device, in which the spatiotemporal data is either event-based data or image frame-based data; capturing motion data associated with movements of the mobile device via an IMU; constructing composite spatiotemporal trajectories of facial features on the person's face by combining the spatiotemporal data and the motion data; matching the composite spatiotemporal trajectories of facial features to a stored template of biometric gestures associated with an authorized user; determining, based on the matching, whether the composite spatiotemporal trajectories of facial features corresponds to the stored template within a predefined threshold; and providing access to a protected asset or secure operation in response to determining that the composite spatiotemporal trajectory corresponds to the stored template within the predefined threshold.

Example 2. The method of example 1, in which spatiotemporal data is spatiotemporal event-based data, and capturing the spatiotemporal event-based data of the user's facial features via a vision sensor includes capturing spatiotemporal event-based data associated with the facial feature movements of the user via an event-based vision sensor configured to detect changes in illumination or contrast at individual sensor pixels and output asynchronous events corresponding to the detected changes.

Example 3. The method of example 2, in which the event-based vision sensor outputs asynchronous events corresponding to changes in illumination or contrast with a temporal resolution of approximately one microsecond.

Example 4. The method of any of examples 1-3, in which capturing the motion data associated with the movement of the mobile device via the IMU includes capturing motion data that identifies a lateral motion of the mobile device, the lateral motion effective to detect information about a depth associated with the facial features of the user.

Example 5. The method of any of examples 1-4, further including processing the spatiotemporal data by aligning and normalizing the data to remove noise and inconsistencies while maintaining temporal resolution prior to constructing the composite spatiotemporal trajectory.

Example 6. The method of any of examples 1-5, in which capturing the spatiotemporal data of the user's facial features via a vision sensor includes capturing sparse spatiotemporal event-based data on the user's facial features that can be matched to previous dynamical trajectories of facial features related to facial expression gestures, mobile device movements, or both combined without capturing images of the user's face.

Example 7. The method of any of examples 1-6, further including: detecting spoofing attempts by analyzing inconsistencies in temporal dynamics or spatial distortions in the captured spatiotemporal data; and initiating a protective action in response to detecting a spoofing attempt.

Example 8. The method of any of examples 1-7, further including generating an alert in response to determining that the composite spatiotemporal trajectories of facial features does not correspond to the stored template within the predefined threshold.

Example 9. The method of any of examples 1-8, further including reconstructing a three-dimensional model of a user's face based on the spatiotemporal data and the motion data.

Example 10. The method of any of examples 1-9, in which matching the composite spatiotemporal trajectory to the stored template of biometric gestures associated with the authorized user includes using a neural network trained on spatiotemporal trajectories of dynamic facial expression gestures and device movements.

Example 11. The method of any of examples 1-10, further including updating the stored template of biometric gestures in response to verified authentication events to adapt to changes in the user's facial features over time.

Example 12. The method of any of examples 1-11, in which providing access to the protected asset or secure operation includes providing access to at least one of: unlocking the mobile device; authorizing a transaction; authorizing use of a vehicle; or granting access to a restricted resource or file.

Example 13. The method of any of examples 1-12, in which capturing the spatiotemporal data of the user's facial features via the vision sensor includes capturing spatiotemporal data of facial features that includes data corresponding to micro-expressions of the user.

Example 14. The method of any of examples 1-13, further including focusing processing of data from the vision sensor on the user's face to facilitate capturing the spatiotemporal data of the user's facial features via the vision sensor.

Example 15. The method of any of examples 1-14, further including dynamically adjusting the predefined threshold based on environmental factors including lighting conditions and mobile device orientation.

Example 16. The method of any of examples 1-15, in which the vision sensor and the IMU are integrated into a single hardware module configured to perform real-time processing of spatiotemporal data.

Example 17. The method of any of examples 1-16, further including performing additional independent authentication methods prior to providing access to the protected asset or secure operation, the additional independent authentication methods including one or more of fingerprint verification, palmprint verification, voiceprint verification, facial recognition, password verification, or two-factor authentication.

Example 18. A method for secure biometric authentication using dynamic facial expression gestures and motion, the method including: capturing spatiotemporal data regarding movements of a user's facial features via a vision sensor, in which the spatiotemporal data is either event-based data or image frame-based data; capturing motion data associated with a movement of a mobile device via an IMU; processing the spatiotemporal data and the motion data in a neural network that is trained to infer whether movements of the user's facial features and mobile device motions match those of an authorized user; and providing access to a protected asset or secure operation in response to the neural network inferring that the dynamic facial features and mobile device motions match those of an authorized user.

Example 19. The method of example 18, in which the spatiotemporal data is event-based data, and capturing the spatiotemporal event-based data regarding movements of a user's facial features via a vision sensor includes capturing spatiotemporal event-based data regarding movements of the user's facial features via an event-based vision sensor configured to detect changes in illumination or contrast at individual sensor pixels and output asynchronous events corresponding to the detected changes.

Example 20. The method of any of examples 18-19, in which the neural network uses PLEIADES processing of the spatiotemporal data and motion data to reduce latency and efficiently process high-frequency data to support dynamic facial expression gesture analyses and inference.

Example 21. The method of any of examples 18-20, in which the spatiotemporal data is frame-based data, and the neural network uses Binned PLEIADES processing of the spatiotemporal data and motion data that looks at multiple frames in the past to perform dynamic facial expression gesture analyses and inference.

Example 22. The method of any of examples 18-21, in which the vision sensor, the IMU, and a neural processing unit (NPU) implementing the neural network are combined in a single integrated circuit assembly.

Example 23. A method of training the neural network of any of examples 18-22, including: capturing spatiotemporal data regarding movements of the user's facial features via a vision sensor and motion data of the mobile device via an IMU in a training session, in which the spatiotemporal data is either event-based data or image frame-based data; and training or fine-tuning the neural network using the captured spatiotemporal data and motion data.

Example 24. The method of example 23, further including prompting the user during the training session to make one or more facial expression gestures to be used for authenticating the user.

Example 25. The method of either examples 23 or 24, further including prompting the user during the training session to move the mobile device through one or more motions to be used for authenticating the user while making the one or more facial expression gestures.

Example 26. A method for secure biometric authentication using dynamic facial expression gestures and motion, the method including: capturing spatiotemporal data of a user's facial features via a vision sensor, in which the spatiotemporal data is either event-based data or image frame-based data; constructing spatiotemporal trajectories of facial features on the person's face; matching the spatiotemporal trajectories of facial features to a stored template of biometric gestures associated with an authorized user; determining, based on the matching, whether the spatiotemporal trajectories of facial features corresponds to the stored template within a predefined threshold; and providing access to a protected asset or secure operation in response to determining that the spatiotemporal trajectory corresponds to the stored template within the predefined threshold.

Example 27. The method of example 26, in which spatiotemporal data is spatiotemporal event-based data, and capturing the spatiotemporal event-based data of the user's facial features via a vision sensor includes capturing spatiotemporal event-based data associated with the facial feature movements of the user via an event-based vision sensor configured to detect changes in illumination or contrast at individual sensor pixels and output asynchronous events corresponding to the detected changes.

Example 28. The method of example 27, in which the event-based vision sensor outputs asynchronous events corresponding to changes in illumination or contrast with a temporal resolution of approximately one microsecond.

Example 29. The method of any of examples 26-28, further including processing the spatiotemporal data by aligning and normalizing the data to remove noise and inconsistencies while maintaining temporal resolution prior to constructing the spatiotemporal trajectory.

Example 30. The method of any of examples 26-29, in which capturing the spatiotemporal data of the user's facial features via a vision sensor includes capturing sparse spatiotemporal event-based data on the user's facial features that can be matched to previous dynamical trajectories of facial features related to facial expression gestures without capturing images of the user's face.

Example 31. The method of any of examples 26-30, further including: detecting spoofing attempts by analyzing inconsistencies in temporal dynamics or image distortions in the captured spatiotemporal data; and initiating a protective action in response to detecting a spoofing attempt.

Example 32. The method of any of examples 26-31, further including generating an alert in response to determining that the composite spatiotemporal trajectories of facial features do not correspond to the stored template within the predefined threshold.

Example 33. The method of any of examples 26-32, further including reconstructing a three-dimensional model of a user's face based on the spatiotemporal data and the motion data.

Example 34. The method of any of examples 26-33, in which matching the composite spatiotemporal trajectory to the stored template of biometric gestures associated with the authorized user includes using a neural network trained on spatiotemporal trajectories of facial features during a dynamic facial expression gesture.

Example 35. The method of any of examples 26-34, further including updating the stored template of biometric gestures in response to verified authentication events to adapt to changes in the user's facial features over time.

Example 36. The method of any of examples 26-35, in which providing access to the protected asset or secure operation includes providing access to at least one of: unlocking a mobile device; authorizing a transaction; authorizing use of a vehicle; or granting access to a restricted resource or file.

Example 37. The method of any of examples 26-36, in which capturing the spatiotemporal data of the user's facial features via the vision sensor includes capturing spatiotemporal data of facial features that includes data corresponding to micro-expressions of the user.

Example 38. The method of any of examples 26-37, further including focusing processing of data from the vision sensor on the user's face to facilitate capturing the spatiotemporal data of the user's facial features via the vision sensor.

Example 39. The method of any of examples 26-38, further including dynamically adjusting the predefined threshold based on environmental factors including lighting conditions and mobile device orientation.

Example 40. A method for secure biometric authentication using dynamic facial expression gestures and motion, the method including: capturing spatiotemporal data regarding movements of a user's facial features via a vision sensor; processing the spatiotemporal data in a neural network that is trained to infer whether movements of the user's dynamic facial feature movements match those of an authorized user; and providing access to a protected asset or secure operation in response to the neural network inferring that the dynamic facial feature movements match those of an authorized user.

Example 41. The method of example 40, in which the spatiotemporal data is event-based data, and capturing the spatiotemporal event-based data regarding movements of a user's facial features via a vision sensor includes capturing spatiotemporal event-based data regarding movements of the user's facial features via an event-based vision sensor configured to detect changes in illumination or contrast at individual sensor pixels and output asynchronous events corresponding to the detected changes.

Example 42. The method of any of examples 40-41, in which the neural network uses PLEIADES processing of the spatiotemporal event-based data to reduce latency and efficiently process high-frequency data to support dynamic facial expression gesture analyses and inference.

Example 43. The method of any of examples 40-42, in which the spatiotemporal data is frame-based data, and the neural network uses Binned PLEIADES processing of the spatiotemporal event-based data that looks at multiple frames in the past to perform dynamic facial expression gesture analyses and inference.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. The processing system (e.g., 604) of various embodiments may include multiple processors including neural network processors, such a one or more NPUs and/or GPUs.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). In addition, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-improved hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A method for secure biometric authentication, the method comprising:
capturing, via a sensor in a mobile device, spatiotemporal data associated with facial features of a user, wherein the spatiotemporal data is either event-based data or image frame-based data;
capturing, via an inertial measurement unit (IMU), motion data associated with a movement of the mobile device;
combining the spatiotemporal data and the motion data into a single data structure to generate a composite spatiotemporal trajectory, the composite spatiotemporal trajectory representing interplay between facial features of the user and the movements associated with the mobile device;
comparing the composite spatiotemporal trajectory with a stored template, the stored template designated as a biometric gesture associated with an authorized user;
determining, based on the comparing, whether the composite spatiotemporal trajectory and the stored template match with each other beyond a predefined threshold value of a similarity measure; and
providing the user access to a protected asset or authorization to perform a secure operation in response to determining that the composite spatiotemporal trajectory and the stored template match with each other beyond the predefined threshold value of a similarity measure.

2. The method of claim 1, wherein the spatiotemporal data is spatiotemporal event-based data, the sensor is an event-based vision sensor, and the capturing the spatiotemporal event-based data of the facial features of the user comprises capturing spatiotemporal event-based data associated with facial feature movements of the user via the event-based vision sensor configured to detect changes in illumination or contrast at individual sensor pixels and output asynchronous events associated with the detected changes.

3. The method of claim 2, wherein the event-based vision sensor outputs asynchronous events corresponding to changes in illumination or contrast with a temporal resolution of approximately one microsecond.

4. The method of claim 1, wherein the capturing the motion data associated with a movement of the mobile device comprises capturing motion data associated with identifying a lateral motion of the mobile device, the lateral motion effective to detect information about a depth associated with the facial features of the user.

5. The method of claim 1, further comprising:
processing the spatiotemporal data by aligning and normalizing the data to remove noise and inconsistencies while maintaining temporal resolution prior to constructing the composite spatiotemporal trajectory.

6. The method of claim 1, wherein capturing the spatiotemporal data of the facial features of the user comprises:
capturing sparse spatiotemporal event-based data associated with the facial features of the user, without capturing an image of a face of the user, the sparse spatiotemporal event-based data being in a format can be matched to a stored dynamical trajectory associated with facial features, the dynamical trajectory representing facial expression gestures, mobile device movements, or both combined.

7. The method of claim 1, further comprising:
detecting an associated with temporal dynamics or spatial distortions in the spatiotemporal data;
detecting a spoofing attempt based on analyzing the inconsistency; and
initiating a protective action in response to detecting the spoofing attempt.

8. The method of claim 1, further comprising:
generating an alert in response to determining that the composite spatiotemporal trajectory and the stored template do not match with each other beyond the predefined threshold value of a similarity measure.

9. The method of claim 1, further comprising:
reconstructing a three-dimensional model of a face of the user based on the spatiotemporal data and the motion data, the three-dimensional model to be used to compare with a stored template of a three-dimensional model of an authorized user.

10. The method of claim 1, wherein comparing the composite spatiotemporal trajectory with the stored template comprises comparing using a neural network trained on a set of spatiotemporal trajectories each spatiotemporal trajectory from the set of spatiotemporal trajectories associated with a dynamic facial expression gesture and a device movement.

11. The method of claim 1, further comprising:
detecting a verified authentication event in response to determining that the composite spatiotemporal trajectory and the stored template match with each other beyond the predefined threshold value of a similarity measure;
updating the stored template designated as the biometric gesture associated with the authorized user in response to detecting the verified authentication event, the updating effective to adapt the stored template to changes in the facial features of the user over time.

12. The method of claim 1, wherein providing the user access to the protected asset or authorization to perform the secure operation comprises providing access to at least one of:
unlocking the mobile device;
authorizing a transaction;
authorizing use of a vehicle; or
granting access to a restricted resource or file.

13. The method of claim 1, wherein capturing the spatiotemporal data of the facial features of the user comprises capturing spatiotemporal data of facial features that includes data associated with a micro-expression of the user.

14. The method of claim 1, further comprising:
focusing processing of data from the sensor on the face of the user to facilitate capturing the spatiotemporal data of the facial features of the user via the sensor.

15. The method of claim 1, further comprising:
dynamically adjusting the predefined threshold value of the similarity measure based on one or more environmental factors including a lighting condition and a mobile device orientation.

16. The method of claim 1, wherein the sensor and the IMU are integrated into a single hardware module configured to perform real-time processing of spatiotemporal data.

17. The method of claim 1, further comprising:
performing an independent authentication check prior to providing access to the protected asset or secure operation, the additional independent authentication check being via a method including one or more of fingerprint verification, palmprint verification, voiceprint verification, facial recognition, password verification, or two-factor authentication.

18. A computing device, comprising:
a processor configured to:
capture, via a sensor in the computing device, spatiotemporal data associated with facial features of a user, wherein the spatiotemporal data is either event-based data or image frame-based data;
capture, via an inertial measurement unit (IMU), motion data associated with a movement of the mobile device;
combine the spatiotemporal data and the motion data into a single data structure to generate a composite spatiotemporal trajectory, the composite spatiotemporal trajectory representing interplay between facial features of the user and the movements associated with the mobile device;
compare the composite spatiotemporal trajectory with a stored template, the stored template designated as a biometric gesture associated with an authorized user;
determine, based on the comparing, whether the composite spatiotemporal trajectory and the stored template match with each other beyond a predefined threshold value of a similarity measure; and
provide the user access to a protected asset or authorization to perform a secure operation in response to determining that the composite spatiotemporal trajectory and the stored template match with each other beyond the predefined threshold value of a similarity measure.

19. A non-transitory processor-readable storage medium having stored thereon processor-executable instructions configured to cause a processor of a computing device to perform various operations for secure biometric authentication, the operations comprising:
capturing, via a sensor in the computing device, spatiotemporal data associated with facial features of a user, wherein the spatiotemporal data is either event-based data or image frame-based data;
capturing, via an inertial measurement unit (IMU), motion data associated with a movement of the mobile device;
combining the spatiotemporal data and the motion data into a single data structure to generate a composite spatiotemporal trajectory, the composite spatiotemporal trajectory representing interplay between facial features of the user and the movements associated with the mobile device;
comparing the composite spatiotemporal trajectory with a stored template, the stored template designated as a biometric gesture associated with an authorized user;
determining, based on the comparing, whether the composite spatiotemporal trajectory and the stored template match with each other beyond a predefined threshold value of a similarity measure; and
providing the user access to a protected asset or authorization to perform a secure operation in response to determining that the composite spatiotemporal trajectory and the stored template match with each other beyond the predefined threshold value of a similarity measure.
